(19) United States
(12) Patent Application Publication
(10) Pub. No.: US 2011/0308441 A1
(43) Pub. Date: Dec. 22, 2011

(54) Personal watercraft apparatuses, systems, and methods

(75) Inventor: Mark S. Peloquin, Vashon, WA (US)

(73) Assignee: Pegalozi, LLC, Seattle, WA (US)

(21) Appl. No.: 12/931,354

(22) Filed: Jan. 29, 2011

Related U.S. Application Data
(60) Provisional application No. 61/336,998, filed on Jan. 29, 2010.

(51) Int. Cl. B63B 13/00; H01R 3/00; F04B 17/03; B63B 17/00; B63B 35/71

(52) U.S. Cl. 114/183 R; 114/347; 114/343; 417/410.1; 174/74 R

(57) ABSTRACT

A system for electrically expelling water from a personal watercraft includes a waterproof container. The waterproof container defines a volume, which contains a portable source of electrical power, the portable source of electrical power is within the waterproof container. A fluid movement device is electrically connected with the portable source of electrical power and the fluid movement device is outside the waterproof container. A switch is electrically connected to the portable source of electrical power, the switch has an on position and an off position. A first mounting bracket has a first end and a second end, the first end has a first mounting position. The fluid movement device is attached at the first mounting position and the second end is held under a seat of the personal watercraft. When the switch is in the on position, the fluid movement device will pump water and when the fluid movement device is in the off position, the pump will not pump water.

### RELATED APPLICATION

This patent application claims priority from U.S. Provisional Patent Application Ser. No. 61/336,998 filed on Jan. 29, 2010, entitled: “Personal Watercraft Apparatuses, Systems, and Methods.” U.S. Provisional Patent Application Ser. No. 61/336,998 filed on Jan. 29, 2010, entitled “Personal Watercraft Apparatuses, Systems, and Methods” is hereby incorporated by reference into the present application.

### BACKGROUND OF THE INVENTION

1. Field of Invention

Embodiments of the invention relate generally to apparatuses and methods for personal watercraft.

2. Art Background

Personal watercraft, such as kayaks and canoes are paddled on lakes, oceans, and rivers by paddlers throughout the world. These watercrafts are less stable when water enters the cockpit making them more likely to overturn. Overturning can be dangerous and in some case life threatening. This risk is mitigated to some degree in kayaks with internal bulkheads. Internal bulkheads limit the amount of water can enter the kayak if capsized. In some kayaks, inflatable air bags are used to limit the amount of water that can enter the kayak. Even with these design features, stability is decreased when the kayak takes on water after a capsize and wet exit.

After the paddler wet exits, rights the kayak, and re-enters the cockpit the paddler pumps out the cockpit with a manual bilge pump. This requires the paddler to have the spray skirt removed from the cockpit coaming during manual pumping. Wave action can cause water to refill the cockpit as the paddler is pumping with the manual bilge pump. In some situations, it is not possible to pump the water out of the cockpit with the manual bilge pump because of the refilling caused by waves and the exhaustion that the paddler experiences during this process. This can present a problem.

To prevent water from entering the cockpit of a decked kayak, the paddler wears a spray skirt. The spray skirt fits snuggly around the paddler's waist and attaches to the cockpit coaming with an elastic perimeter. During paddling on rivers, lakes, or on the ocean, water works its way into the cockpit through the interface between the spray skirt and the paddler and through the interface between the spray skirt and the coaming of the cockpit. Water in the kayak decreases stability and present a problem. Current methods of expelling this water are performed by hand by removing the spay skirt and using manual bilge pumps and sponges. Taking the spray skirt off exposes the paddler to the risk of more water entering the cockpit. This can present a problem.

When students are learning skills needed to kayak, such as rolling, bracing, and edging the kayak to turn they sometimes tip over and have to wet exit. Following a wet exit, students spend a long time pumping water out of the flooded cockpit by hand with a manual bilge pump, typically 4-6 minutes in a single person kayak with bulkheads. In a kayak without bulkheads or in multi-person kayaks the time to empty the cockpit by manual pumping is much longer. For this reason, some students avoid wet exiting and learn skills very slowly due to their fear of wet exiting. This can present a problem.

Kayaks have storage below deck and food is typically stored below deck. Kayaks do not have structures to permit food and drinks to be accessed from above deck. A paddler can spend a long time on the water and become hungry or thirsty without access to food or drinks, this can present a problem.

### BRIEF DESCRIPTION OF THE DRAWINGS

The invention may best be understood by referring to the following description and accompanying drawings that are used to illustrate embodiments of the invention. The invention is illustrated by way of example in the embodiments and is not limited in the figures of the accompanying drawings in which like references indicate similar elements.

FIG. 1A illustrates a system for expelling water from a personal watercraft electrically according to embodiments of the invention.

FIG. 1B illustrates an isometric view of a switch for a personal watercraft utilizing an embodiment of the invention.

FIG. 1C illustrates an isometric view of a switch mounting device according to embodiments of the invention.

FIG. 1D illustrates an isometric view of a switch mounting device from FIG. 1C.

FIG. 1E illustrates a system for expelling water from a personal watercraft electrically according to various embodiments of the invention.

FIG. 1F illustrates the electrical circuit of a system for expelling water from a personal watercraft electrically according to embodiments of the invention.

FIG. 1G illustrates a wiring harness and associated components for a personal watercraft according to embodiments of the invention.

FIG. 1H illustrates an alternative system for charging a portable source of electrical power in a system used in a personal watercraft according to embodiments of the invention.

FIG. 2A illustrates a top view of a mounting bracket and pump system according to an embodiment of the invention.

FIG. 2B illustrates another top view of a mounting bracket and pump system according to an embodiment of the invention.

FIG. 2C illustrates a top view of a mounting bracket and pump system according to another embodiment of the invention.

FIG. 2D illustrates a top view of a mounting bracket and pump system according to yet another embodiment of the invention.

FIG. 2E illustrates an isometric view of a pump system installed in a personal watercraft according to another embodiment of the invention.

FIG. 2F illustrates a top view of two mounting brackets according to an embodiment of the invention.

FIG. 2G illustrates additional configurations of mounting brackets according to various embodiments of the invention.

FIG. 3 illustrates an isometric cut-away view of a system for expelling water using a thru-hull fitting according to an embodiment of the invention.

FIG. 4 illustrates an isometric cut-away view of a system for expelling water using an aft mounted thru-hull fitting according to another embodiment of the invention.

FIG. 5 illustrates an isometric cut-away view of a system for expelling water that does not use a thru-hull fitting according to an embodiment of the invention.

FIG. 6 illustrates an isometric cut-away view of a system for expelling water that does not use a thru-hull fitting according to another embodiment of the invention.

FIG. 7A illustrates a cross sectional view of a device for expelling water that does not use a thru-hull fitting according to an embodiment of the invention.

FIG. 7B illustrates a top view of the device from FIG. 7A according to an embodiment of the invention.

FIG. 8A illustrates a top view of a water confinement system according to an embodiment of the invention.

FIG. 8B illustrates a side view of the system shown in FIG. 8A according to an embodiment of the invention.

FIG. 8C illustrates a top view of a water confinement system according to another embodiment of the invention.

FIG. 8D illustrates a top view of a water confinement system according to yet another embodiment of the invention.

FIG. 9A illustrates a side cut-away view of a portable system for expelling water according to an embodiment of the invention.

FIG. 9B illustrates an isometric view of the system shown in FIG. 9A according to an embodiment of the invention.

FIG. 9C illustrates an isometric view of a hybrid electric/mechanical portable system for expelling water according to an embodiment of the invention.

FIG. 9D illustrates another isometric view of a hybrid electric/mechanical portable system for expelling water with detail according to an embodiment of the invention.

FIG. 10A illustrates an isometric view of a cup/mug holding device for a personal watercraft according to an embodiment of the invention.

FIG. 10B illustrates a top and side view of the holding device from FIG. 10A according to an embodiment of the invention.

FIG. 10C illustrates a side view of a cup/mug holder for a personal watercraft according to another embodiment of the invention.

FIG. 10D illustrates a side view of a cup/mug holder for a personal watercraft according to another embodiment of the invention.

FIG. 10E illustrates an isometric view of a plate/bowl holder for a personal watercraft according to another embodiment of the invention.

### DETAILED DESCRIPTION

In the following detailed description of embodiments of the invention, reference is made to the accompanying drawings in which like references indicate similar elements and in which are shown by way of illustrations, specific embodiments in which the invention may be practiced. These embodiments are described in sufficient detail to enable those of skill in the art to practice the invention. In other instances, well-known circuits, structures, and techniques have not been shown in detail in order not to obscure the understanding of this description. The following detailed description is, therefore, not to be taken in a limiting sense and the scope of the invention is defined only by the appended claims.

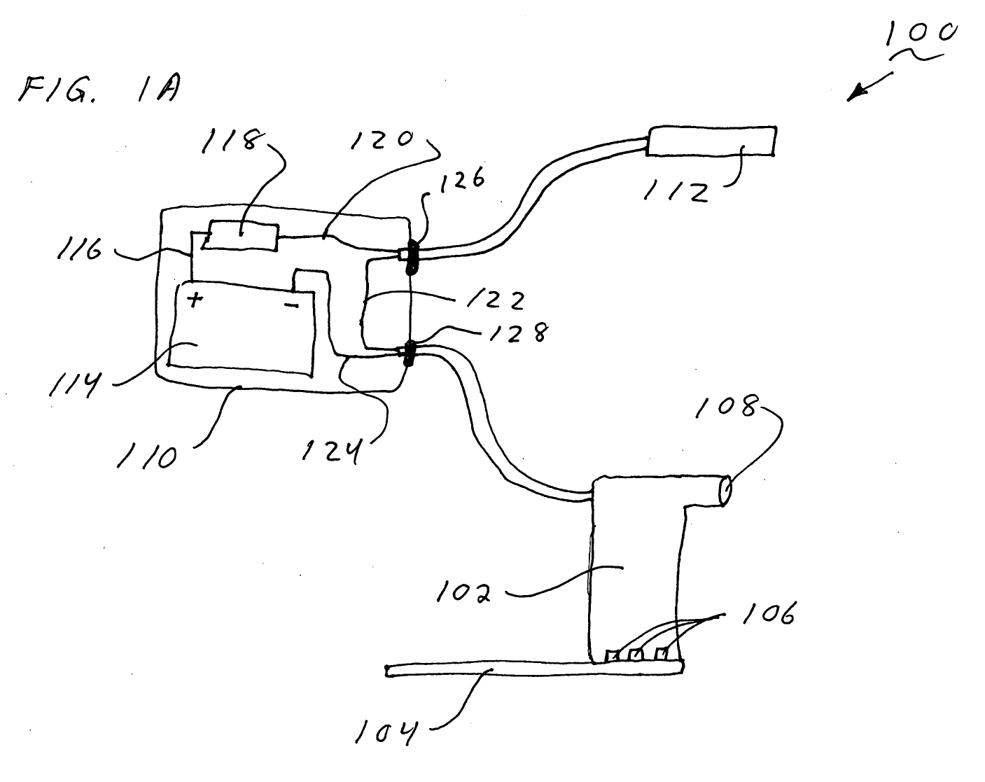

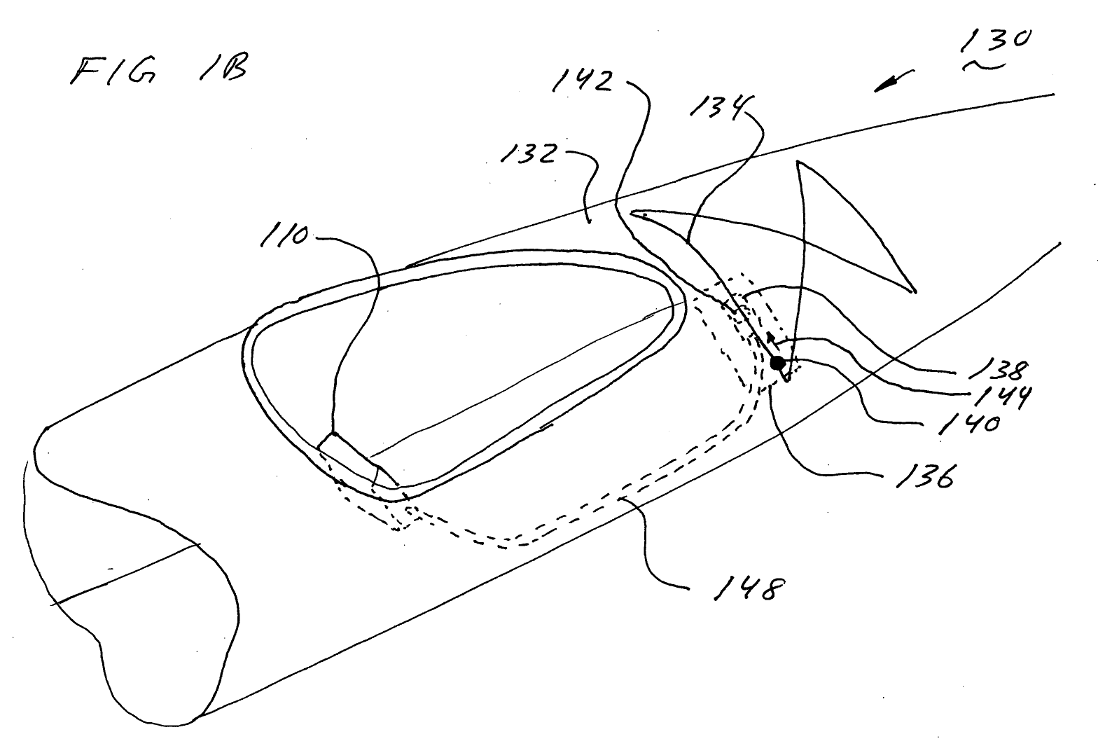

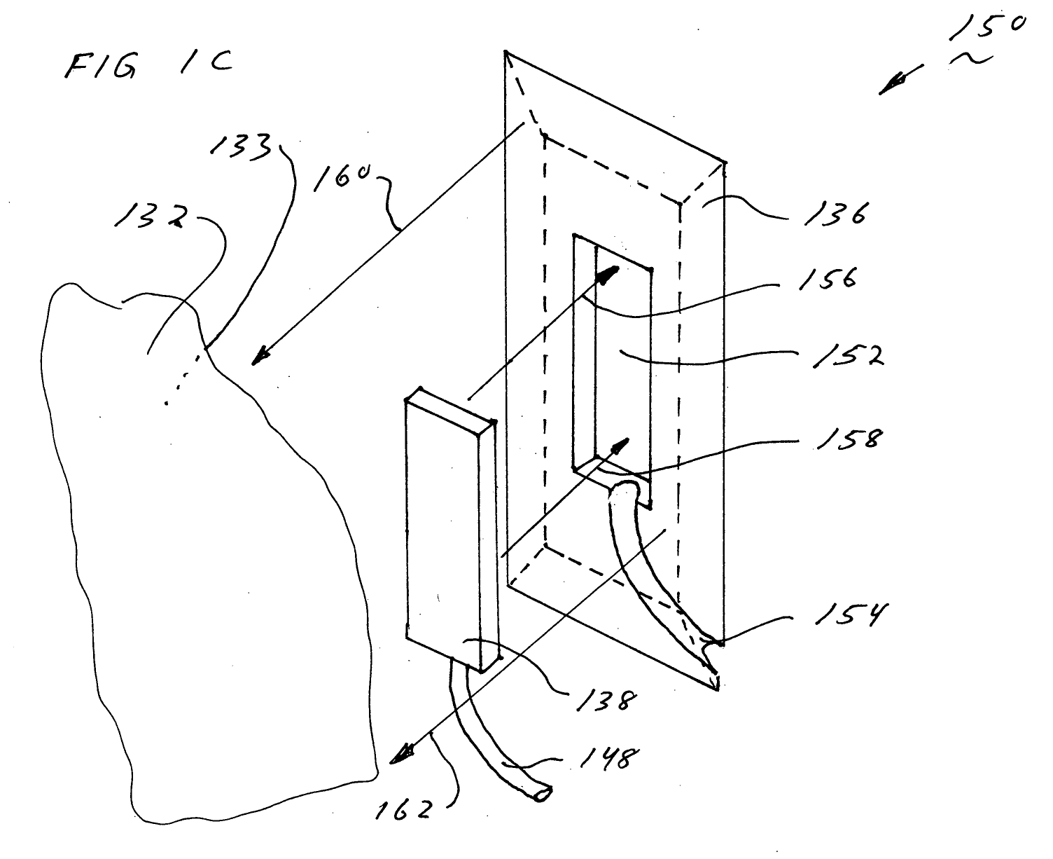

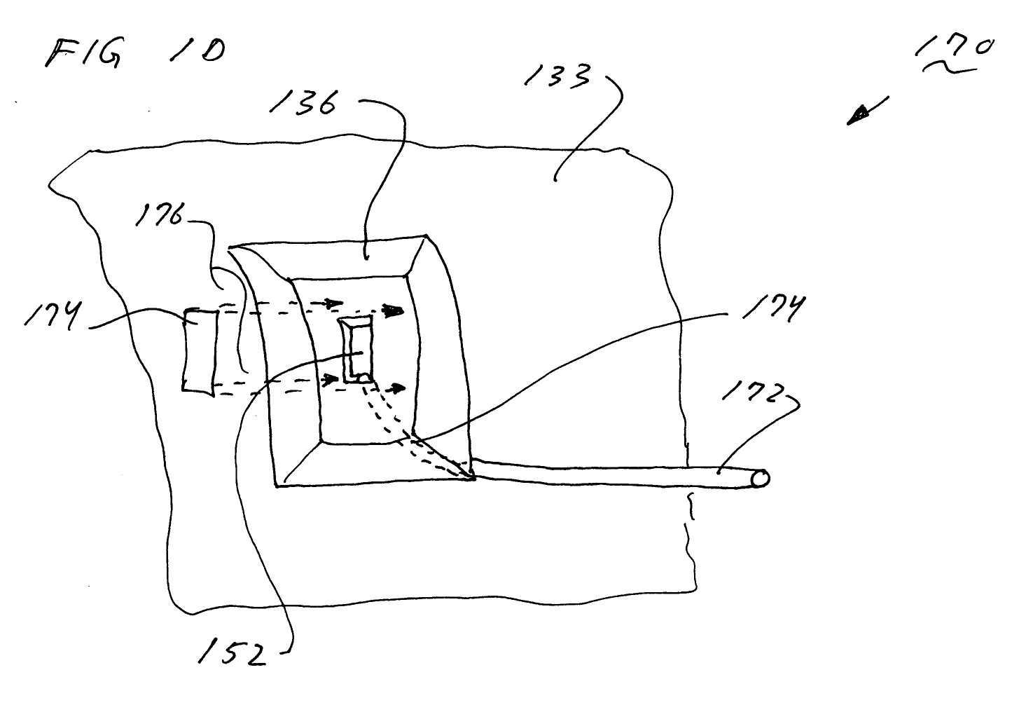

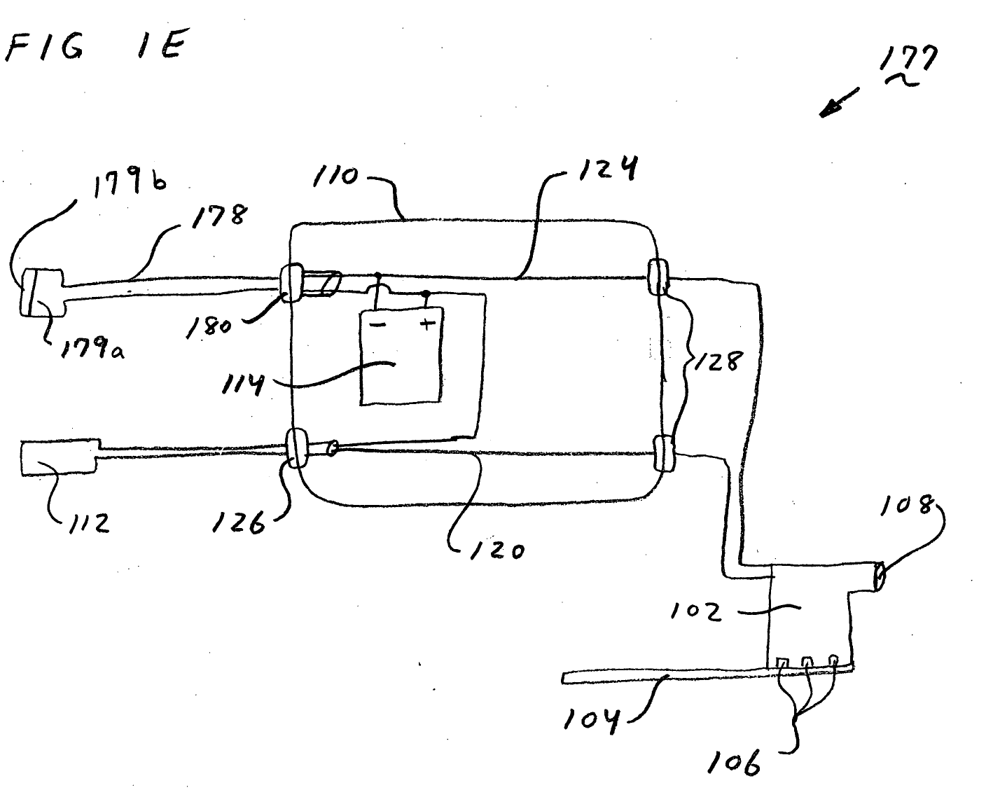

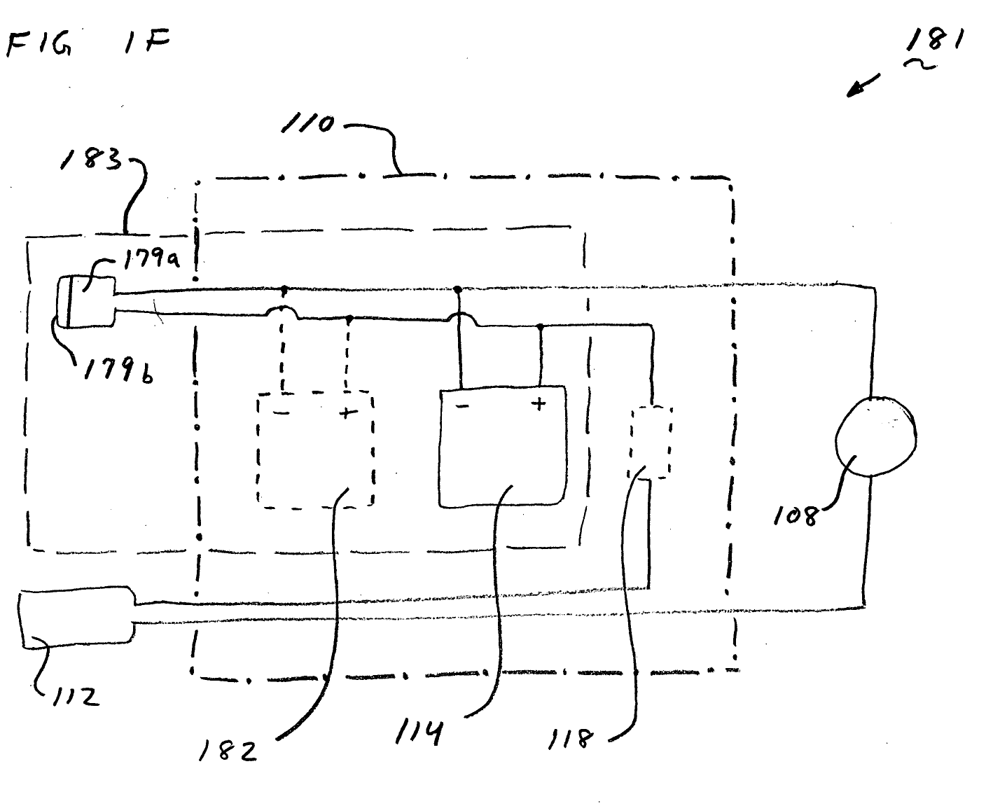

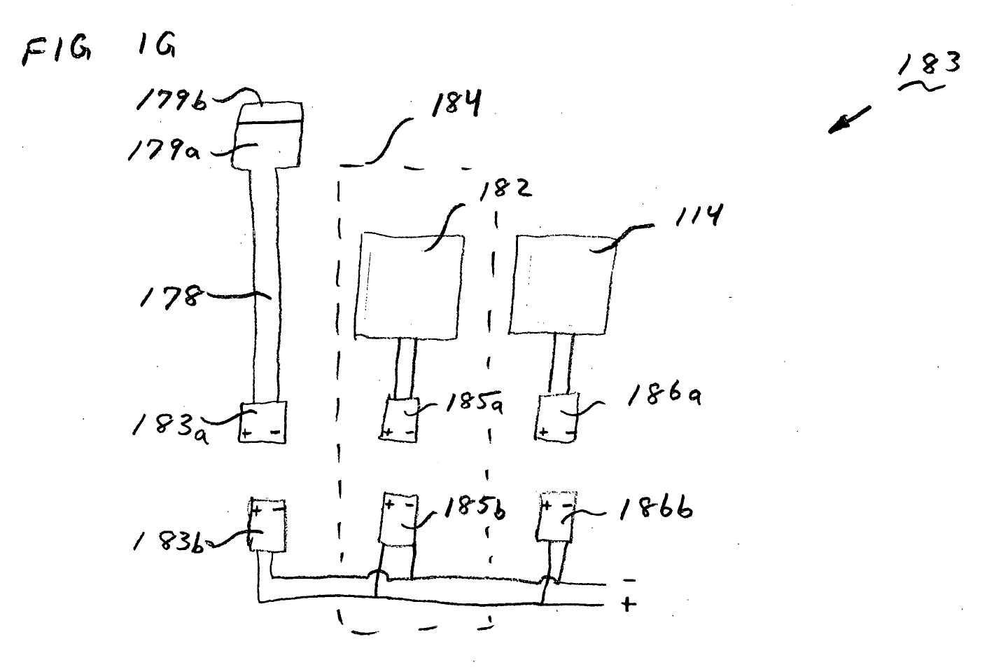

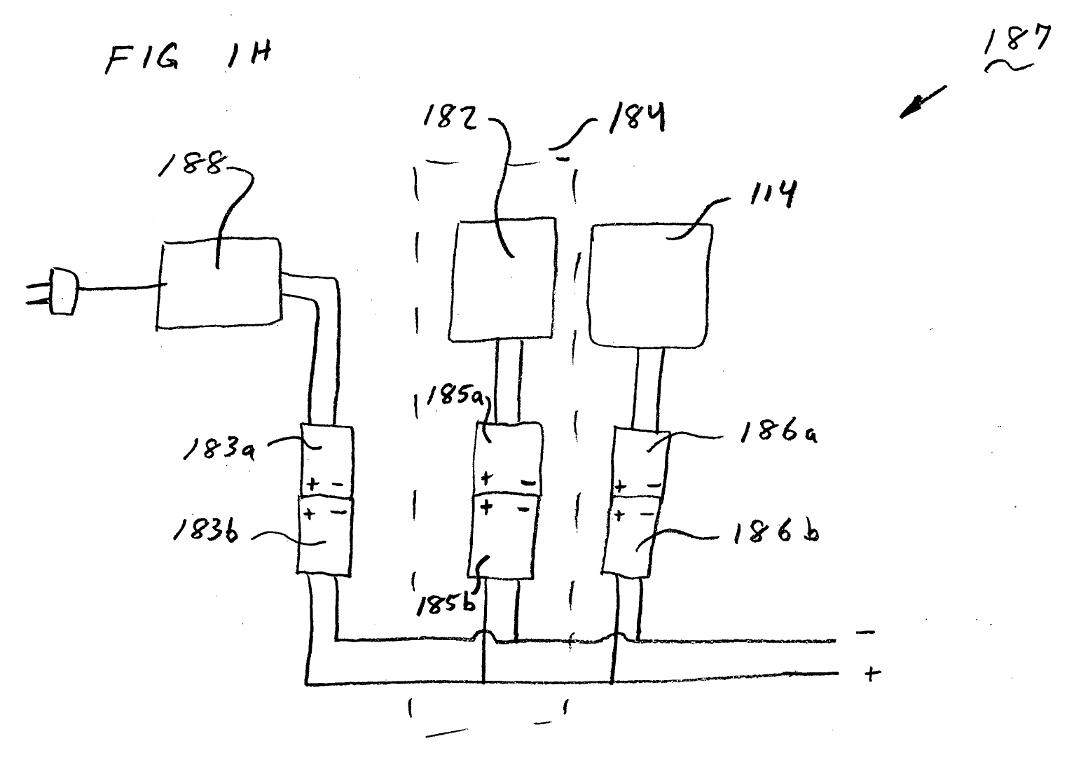

FIG. 1A illustrates, generally at 100, a system for expelling water from a personal watercraft electrically according to embodiments of the invention. With reference to FIG. 1A, the system 100 includes a weatherproof compartment 110. Waterproof compartment 110 contains a portable source of electrical power 114, an electrical conductor 116 connects to an optional fuse 118. An electrical conductor 120 connects the fuse 118 to a switch 112. Another electrical conductor 122 is connected to the switch 112. In one embodiment, electrical conductors 120 and 122 pass through a weatherproof fitting 126 in the weatherproof compartment 110. Note that the weatherproof compartment 110 can be opened so that the inside volume can be accessed. An O-ring seal or gasket is typically used to prevent water ingress into the dry volume of the weatherproof compartment 110. The seal is used between mating parts of the compartment 110 such as for example between a box and lid configuration or generally between mating parts of the weatherproof compartment 110. The view presented in FIG. 1A the weatherproof compartment 110 is open in order to provide an unobscured view of the interior of the weatherproof compartment 110 and the lid or other mating part is not shown for clarity of illustration. In normal operation, the weatherproof compartment 110 is closed to prevent entry of water. The weatherproof compartment 110 is also known as a dry box. The weatherproof compartment 110 is made from plastic such ABS plastic or polycarbonate. The weather proof compartment can be made from other materials such as stainless steel, composites of fiber and resin, wood, etc.

In various embodiments, the fuse 118 can be located outside of the weatherproof compartment 110, such as in either of electrical conductors 122 or 124 in between fluid movement device 102 and a waterproof fitting 128 (external to the weather proof compartment 110) or at another point in the circuit within the weather proof compartment 110.

Switch 112 can be a magnetic reed switch, a toggle switch, a push button switch, or any other type of switch that is configured to switch the flow of electrical current on and off. One source of magnetic reed switches suitable for use herein are those made by AMSECO® and distributed by MOUSER® Electronics that can switch a level of current sufficient to run the fluid movement device 102. A switch capable of switching 3 amps of current at 12 to 16 volts is adequate to run a fluid movement device capable of pumping water at a rate of 500 gallons per hour. A non-limiting example of a fluid movement device that can be used herein are bilge pumps made by Whale® and Rule® such as the Orca® 500 from Whale® or the Rule® 500. Different types of magnets can be used to actuate a magnetic reed switch, such as Alnico magnets, rare earth magnets such as Neodymium, etc.

A fluid movement device 102 has electrical conductors that pass through the weatherproof fitting 128 and into the weatherproof compartment 110. Electrical conductors 124 and 122 connect to the source of electrical power 110 and the switch 112 respectively.

Weatherproof and waterproof are used interchangeably in this description of embodiments. The weatherproof compartment 110 and weatherproof fittings 126 and 128 should be selected to resist water ingress pressures of several pounds per square inch. In one embodiment, rubber grommets can be used for weatherproof fittings 126 and 128. Alternatively, a bulkhead fitting and mating weatherproof connector can be used in place of grommets.

The fluid movement device 102 has fluid input ports 106 and one or more fluid output ports 108. In one embodiment, the fluid movement device 102 is connected to a mounting bracket 104. In one or more embodiments, the fluid movement device 102 is a pump such as a centrifugal pump or a piston pump a diaphragm pump or another type or pump configured to move fluids such as liquid, gas or liquid and gas.

In various embodiments, the portable sources of electrical power shown in this description of embodiments such as 114 (FIG. 1A), 114 (FIG. 1E) 114 and 182 (FIG. 1F), 182 and 114 (FIG. 1G, FIG. 1H), etc. is a battery. The battery can be implemented with various chemistries such as a Nickel Cadmium (NiCd), Nickel Metal Hydride (NiMH), Lithium Ion (Li-Ion), Lithium Polymer (Lipo), Lithium Ferro Phosphate (LiFePO4) or other battery chemistries yet to be developed. The battery chemistry does not limit embodiments of the invention.

FIG. 1B illustrates, generally at 130, an isometric view of a switch for a personal watercraft utilizing an embodiment of the invention. With reference to FIG. 1B; a personal watercraft deck 132 has a deck line 134. A switch mounting device 136 is shown below the deck 132. In an embodiment that uses a magnetic reed switch 138 mounted below the deck 132 in the mounting device 136, an actuator magnet 140 travels on the deck line 134 between an off position, as shown at 140, and an on position as shown at 142. Arrow 144 indicates a line of travel for the actuator magnet 140 between the off and on positions. Electrical cable 148 connects the switch 138 with a weatherproof container 110. Weatherproof container 110 contains a portable source of electrical power for operating fluid movement devices such as 102 (FIG. 1A) or other fluid movement devices illustrated in the figures below.

FIG. 1C illustrates, generally at 150, an isometric view of a switch mounting device according to embodiments of the invention. With reference to FIG. 1C, in one embodiment, a switch mounting device 136 has a recess 152 to receive the switch 138 as indicated by arrows 156 and 158. The switch mounting device 136 has a recess 154 for receiving the electrical cable 148.

In one embodiment, the switch mounting device 136 is attached to the inside surface 133 of the deck 132 as shown by arrows 160 and 162.

FIG. 1D illustrates, generally at 170, an isometric view of a switch mounting device from FIG. 1C. With reference to FIG. 1C, in one embodiment, the switch 138 is placed into the recess 152 and the electrical cable 148 is placed into the recess 154. Then the assembly is attached to the inside surface 133. A suitable adhesive or mechanical mount is used to attach the switch mounting device 136 to the inside surface 133. Suitable adhesives include but are not limited to contact cement, two way tape, etc. In one or more embodiments 136 is made from a piece of foam. It is preferable to make 136 from a closed cell foam that does not absorb water. However, open cell foam can be used as well.

With reference to FIG. 1D, in another embodiment, a tube 172 is inserted into the recess 154 and the switch mounting device 136 is attached to the inside surface 133. The electrical cable 148 (FIG. 1C) can then be inserted and fed into the tube 172 and the switch 138 (FIG. 1C) can then be inserted into recess 152. A cover 174 is then placed over switch mounting device 136 as shown by arrows 176 and is fixed in place with a suitable adhesive, or by using a mechanical fastener such as Velcro®, etc. A thin layer of foam can also be placed over the tube 172, thereby fixing the tube to the inside surface of the cockpit of the personal watercraft. in one embodiment the dimensions of this thin layer of foam are four (4) inches by one quarter (¼) inch by twenty four (24) inches.

In various embodiments, the switch mounting device 136 is made from a closed cell foam. The cover 174, and thin layer of foam can also be made from closed cell foam or alternatively from a thin layer of material.

The switch mounting device 136 and the cover 174 are preferably made from a light weight closed cell foam that does not absorb water. Types of foam that can be used for this purpose include but are not limited to Minicell® foam, Alveolit® foam, Softlon®. Minicell® foam is a chemically cross-linked polyethylene foam that can be fixed to the inside surface of the personal watercraft with an adhesive such as 3M's Scothweld®, Weldood® contact cement, or West System's G/Flex® epoxy

FIG. 1E illustrates, generally at 177, a system for expelling water from a personal watercraft electrically according to embodiments of the invention. With reference to FIG. 1E, the system 177 includes a weatherproof compartment 110. Within the dry volume of weatherproof the compartment 110 is a portable source of electrical power 114. A charging cable 178 has a first end within the weatherproof compartment 110, which is connected to the portable source of electrical power 114. The connection of the first end to the source of electrical power is either made by hardwiring, such as by soldering, or is releasably coupleable with an electrical/mechanical connector. The second end the charging cable is outside of the weatherproof compartment 110 and has a waterproof electrical/mechanical connector 179a attached thereto. A sealing cap 179b mates with the waterproof electrical/mechanical connector 179a to prevent water ingress when in a wet environment.

The charging cable 178 passes through a weatherproof fitting 180. In one embodiment, weatherproof fitting 180 is an elastic grommet that provides a tight fit between the weatherproof the compartment 110 and the charging cable 178. In another embodiment, a weatherproof bulkhead fitting and mating connector can be used to bring the charging cable electrical conductors to the inside of weatherproof compartment 110. In yet another embodiment, a sealant such as epoxy, urethane, or silicone can be used to seal the charging cable to the weatherproof compartment 110.

Similarly, weatherproof fittings 126 and 128 are implemented with grommets, waterproof bulkhead fitting, and mating connector, or a sealant such as epoxy, urethane, silicone, or similar materials. In FIG. 1E electrical conductors 124 and 120 are shown passing into the weatherproof compartment 110 through separate weatherproof fittings 128. In another embodiment, these conductors can pass through a single grommet that accommodates multiple conductors, or the electrical conductors 124 and 120 can be contained within a cable and then the cable passes through a single weatherproof fitting 128. An optional fuse (not shown) can be installed between the portable source of electrical power 114 and the fluid movement device 102, either inside of or outside of the weatherproof compartment 110.

FIG. 1F illustrates, generally at 181, the electrical circuit of a system for expelling water from a personal watercraft electrically according to embodiments of the invention. With reference to FIG. 1F, the system 181 includes a weatherproof compartment 110. Within an envelope of the weatherproof compartment 110 (indicated by dashed line) is a portable source of electrical power 114 and an optional second source of electrical power 182. An optional fuse 118 is illustrated within the envelope of weatherproof compartment 110. Components that are connected to a wiring harness are indicated within dashed line 183 and are described in FIG. 1G below.

FIG. 1G illustrates, generally at 183, a wiring harness and associated components for a personal watercraft. With reference to FIG. 1G the configuration 183 includes a charging cable 178 having a first end with a first electrical/mechanical connector 183a and a second end with a waterproof electrical/mechanical connector 179a. A removable weatherproof sealing cap 179b is releasably coupleable to the waterproof electrical/mechanical connector 179a.

A wiring harness consists of a second electrical/mechanical connector 183b, a third electrical/mechanical connector 186b, and an optional fourth electrical/mechanical connector 185b. The second electrical/mechanical connector 183b is releasably coupleable to the first electrical/mechanical connector 183a. The third electrical/mechanical connector 186b is releasably coupleable to an electrical/mechanical connector 186a. The electrical/mechanical connector 186a is attached to a portable source of electrical power 114.

An optional fourth electrical/mechanical connector 185b is releasably coupleable to an optional electrical/mechanical connector 185a. The electrical/mechanical connector 185a is connected to an optional portable source of electrical power 182.

Following the process described above, the portable sources of electrical power 114 (and optional source 182) are charged without having to open the weatherproof compartment 110 by connecting a charging potential to the waterproof electrical/mechanical connector 179a. Water ingress and the resulting corrosion is a major source of failure in electrical systems that are used in water. Charging the portable sources of electrical power without having to open the weatherproof compartment 110 reduces the risk of water ingress into the weatherproof compartment 110 and extends the useful life span of the overall system.

FIG. 1H illustrates an alternative system for charging a portable source of electrical power in a system used in a personal watercraft. With reference to FIG. 1H a configuration 187 illustrates the situation where the waterproof electrical/mechanical connector 179a has been removed from the system and the container 110 has been opened to permit an alternative method of charging the portable source of electrical power 114 (and optional second source 182). In such a case, the first electrical/mechanical connector 183a (on charging cable 178 FIG. 1G) is removed from the second electrical/mechanical connector 183b and a charging potential 188 is connected with an electrical/mechanical connector 183a directly to the second electrical/mechanical connector 183b. A need for this alternative charging situation can result from user error where water got into the waterproof electrical/mechanical connector 179a because of improper use of the sealing cap 179b. In other cases, a user might prefer to open the weatherproof compartment 110 and charge the portable source of electrical power (and optional second source 182) without using the charging cable 178.

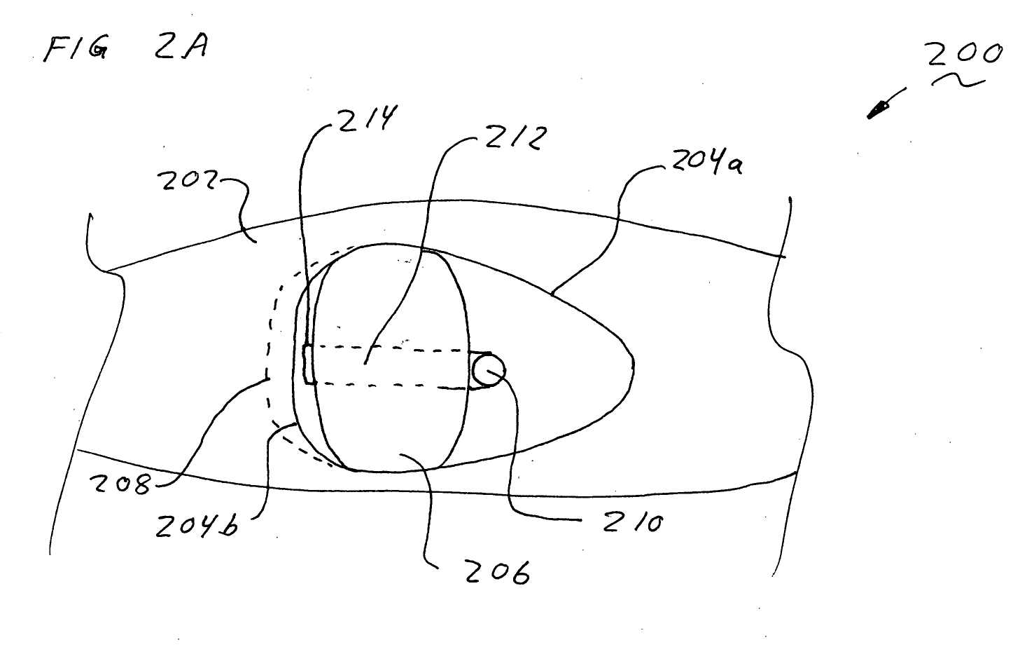

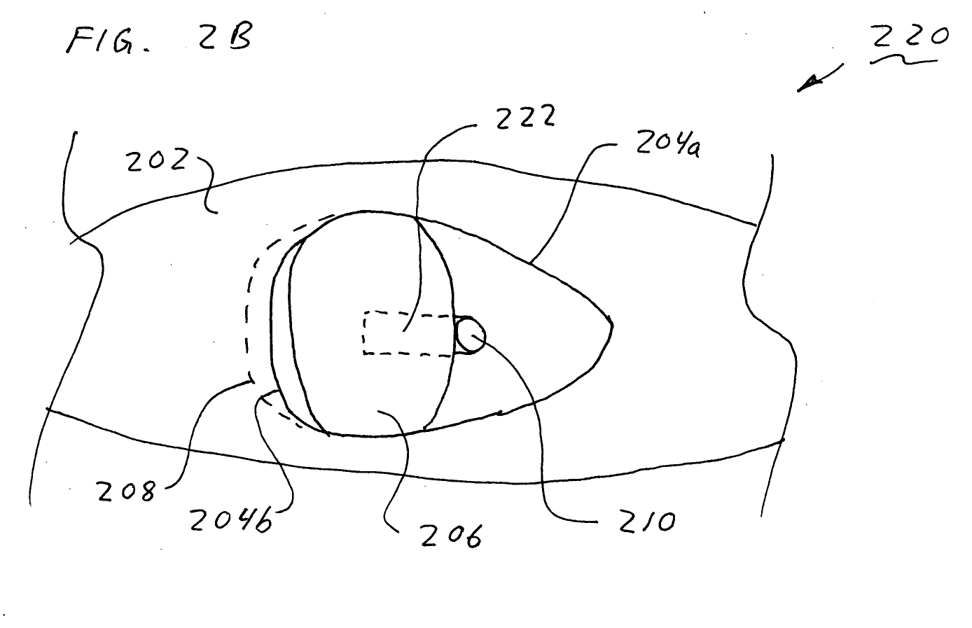

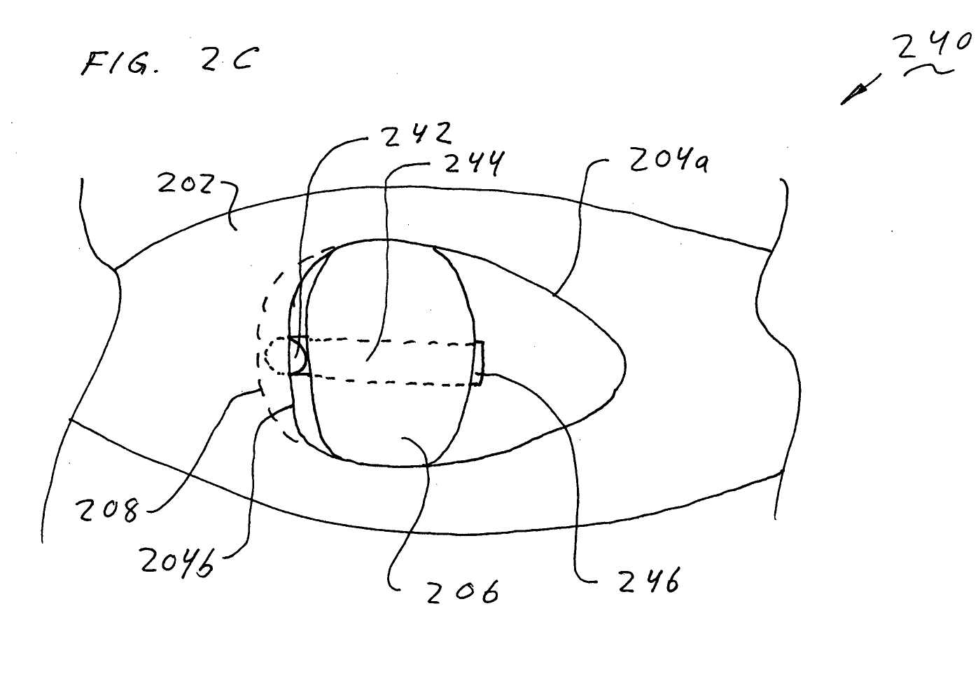

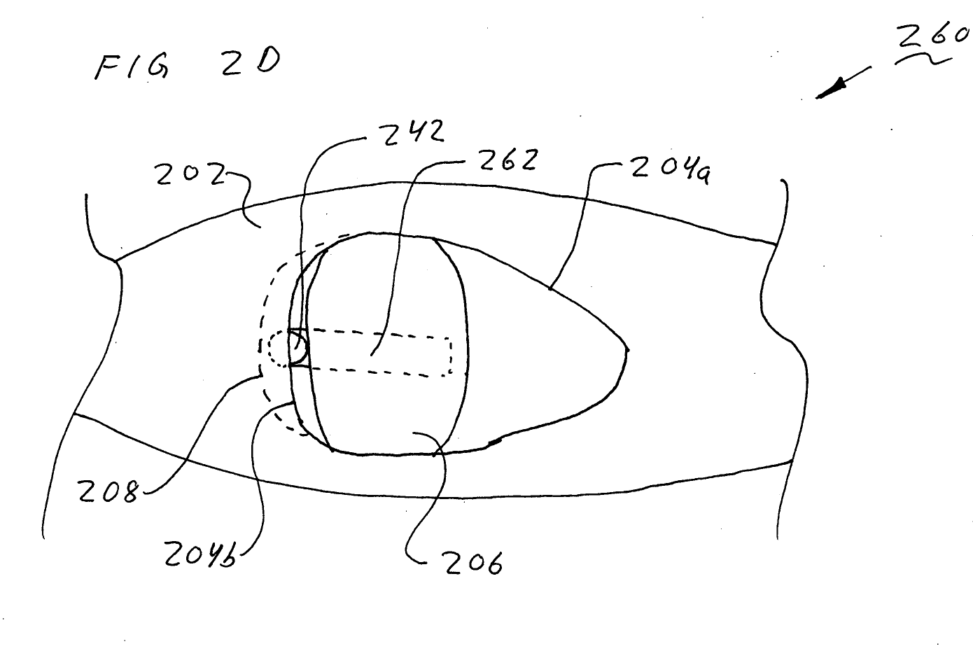

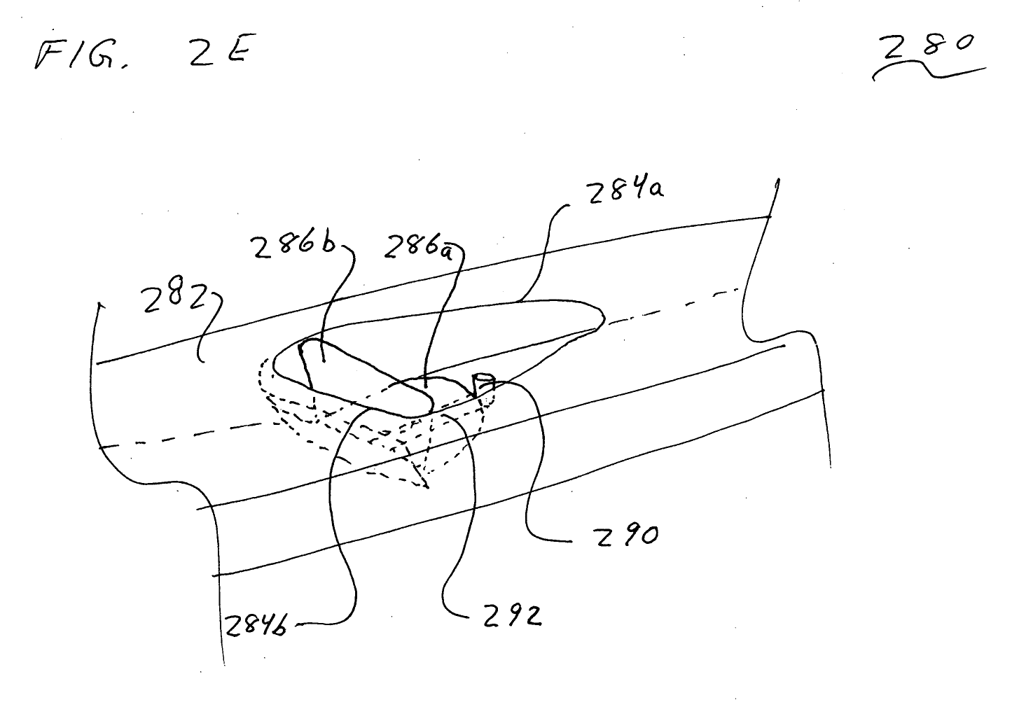

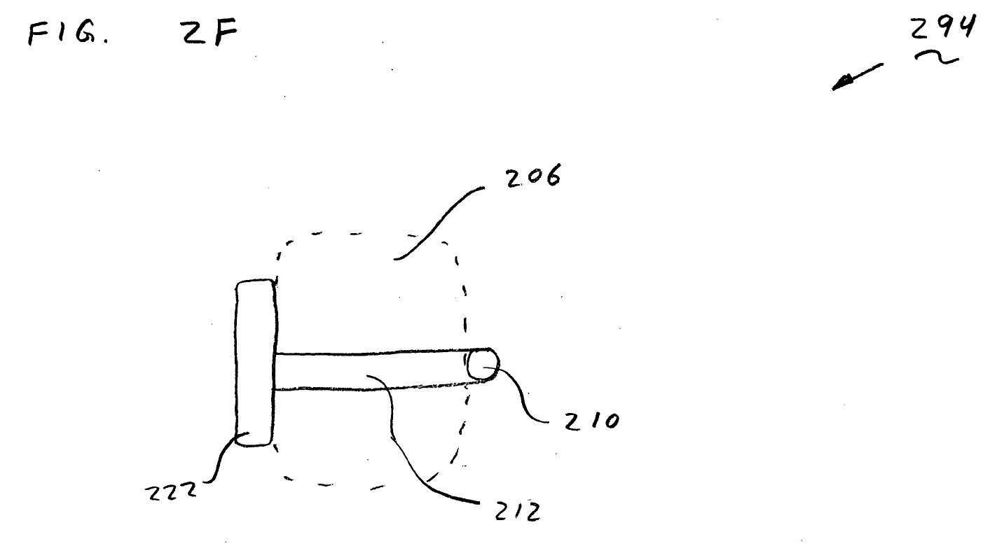

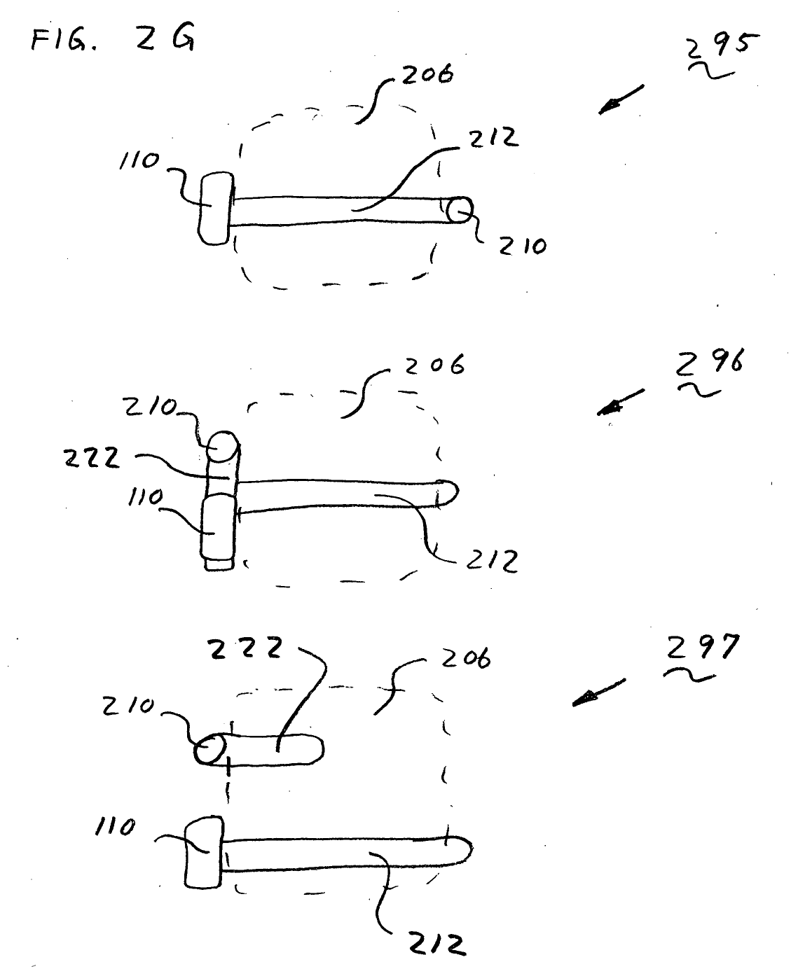

FIG. 2A illustrates a top view, generally at 200, of a mounting bracket and pump system according to an embodiment of the invention. With reference to FIG. 2A, a deck 202 of a personal watercraft has an opening defined by a forward portion 204a and an aft portion 204b. A fluid movement device 210 is coupled to a mounting bracket 212; mounting bracket 212 is located under a seat 206. Mounting bracket 212 extends long the full length of the seat 206. An aft cockpit bulkhead is indicated at 208. In various embodiments, an attachment line (not shown) can be used to secure 212 to 206, 208, 202, 204b or another suitable location within the cockpit of the personal watercraft. In some installations, there will be enough friction between the seat 206 and the floor of the personal watercraft to keep the mounting bracket 212 in place without an attachment line.

FIG. 2B illustrates, generally at 220, another top view of a mounting bracket and pump system according to an embodiment of the invention. With reference to FIG. 2B, a mounting bracket is indicated at 222. The mounting bracket 222 does not extend along the full length of the seat 206. An attachment line (not shown) can be used to secure 222 to 208, 202 or another suitable location within the cockpit of the personal watercraft. In some installations, there will be enough friction between the seat 206 and the floor of the personal watercraft to keep the mounting bracket 222 in place without an attachment line.

FIG. 2C illustrates, generally at 240, a top view of a mounting bracket and pump system according to another embodiment of the invention. With reference to FIG. 2C, a fluid movement device 242 is located aft of the seat 206. In one embodiment, 242 is coupled to a mounting bracket 244. The mounting bracket 244 extends along the full length of the seat 206. The mounting bracket 244 can extend beyond the edge of the seat 206, end just at the edge of seat 206 or be shorter than the length of seat 206 as shown in FIG. 2D. An attachment line (not shown) can be used to secure the mounting bracket 212 to 206, 208, 212, 204b or another suitable location within the cockpit of the personal watercraft. In some installations, there will be enough friction between the seat 206 and the floor of the personal watercraft to keep the mounting bracket 244 in place without an attachment line.

FIG. 2D illustrates a top view of mounting bracket and pump system according to yet another embodiment of the invention. 242 is coupled to a mounting bracket 262. In one embodiment, the mounting bracket 262 extends along the seat 206 and is shorter than the length of seat 206. An attachment line (not shown) can be used to secure the mounting bracket 262 to 206, 208, 212, 204b or another suitable location within the cockpit of the personal watercraft. In some installations, there will be enough friction between the seat 206 and the floor of the personal watercraft to keep the mounting bracket 262 in place without an attachment line.

FIG. 2E illustrates, generally at 280, an isometric view of a pump system installed in a personal watercraft according to another embodiment of the invention. With reference to FIG. 2E, a cockpit opening in a deck 282 has a forward portion 284a and an aft portion 284b. In one embodiment, a seat 286a has a backrest 286b. In one embodiment, a water movement device 290 is coupled to a mounting bracket 292. In one embodiment, the mounting bracket 292 is inserted under 286a.

FIG. 2F illustrates a top view of two mounting brackets according to an embodiment of the invention. With reference to FIG. 2F, the seat 206 from the personal watercraft described in FIG. 2A-FIG. 2E is shown without the personal watercraft for clarity of illustration. A first mounting bracket is indicated at 212 (FIG. 2A) and a second mounting bracket is indicted at 222 (FIG. 2B). These two mounting brackets can be used together as shown in FIG. 2F by fastening the mounting brackets together with fasteners such as bolts or tie wraps. In one embodiment, the first mounting bracket is attached to the second mounting bracket and the resulting “T-shaped” structure is inserted from the aft of left side of the seat as illustrated in FIG. 2F. A fluid movement device 210 is attached to the first mounting bracket 212. In an alternative mounting method, the fluid movement device 210 is attached to the mounting bracket 212, then the mounting bracket 212 is slid under the seat 206 from the forward end (right side) of the seat. This T-shaped mounting bracket serves to keep the fluid movement device in place within the personal watercraft without the need to secure the mounting bracket in place with mechanical fasteners.

FIG. 2G illustrates additional configurations of mounting brackets according to various embodiments of the invention. With reference to FIG. 2G, view 295 illustrates attaching a weatherproof compartment 110 to one end of a first mounting bracket 212 (in the case illustrated the aft end of the mounting bracket 212). A fluid movement device 210 is attached to the other end of the first mounting bracket (in the case illustrated the forward end of the first mounting bracket 212)

With reference to FIG. 2G, in view 296 a first mounting bracket 212 is attached to a second mounting bracket 222 as previously described above in FIG. 2F. A weatherproof compartment 110 is fastened to a first end of the second mounting bracket 222 and a fluid movement device 210 is attached to a second end of the second mounting bracket. The weatherproof compartment 110 can be attached to the second mounting bracket in various ways, for example by using a bungee cord, a strap, or with an additional bracket (not shown) fastened to the second mounting bracket 222.

With reference to FIG. 2G, view 297 illustrates use of two mounting brackets which are not attached together. A fluid movement device 210 is fastened to an end of the second mounting bracket. During installation in a personal watercraft, the second mounting bracket slides between the floor of the personal watercraft and the underside of the seat 206 from the aft end of the seat (left side). Such an installation in a personal watercraft permits the fluid movement device to be mounted to one side of the keel of the personal watercraft. Similarly, a weatherproof compartment 110 is attached to an end of a first mounting bracket 212. During installation in a personal watercraft, the first mounting bracket 212 slides between the floor of the personal watercraft and the underside of the seat 206 from the aft end of the seat 206 (left side).

The mounting brackets described in the foregoing description of embodiments, i.e., 104, 212, 222, 244, 262, and 292 are made from a lightweight plastic such as polycarbonate, polyethylene, ABS, or other suitable plastic. Typical non-limiting thicknesses of the mounting brackets are between 0.90 inch to 0.125 inch. When a mounting bracket is installed between the seat and the floor of a personal watercraft, it is desirable to keep the thickness of the mounting bracket to a minimum. In various embodiments, mounting brackets can be thicker or thinner than the dimensions listed above. Embodiments of the invention are not limited by the dimensions of the mounting bracket. In other embodiments, stainless steel, wood or fiber and resin composites can be used for the mounting bracket(s). A typical width of the mounting bracket is three inches and typical lengths are between 8 inches to 24 inches. The length of the mounting bracket does not limit embodiments of the invention. In various embodiments, the length of the mounting bracket is adjusted to suit the geometry of the particular personal watercraft.

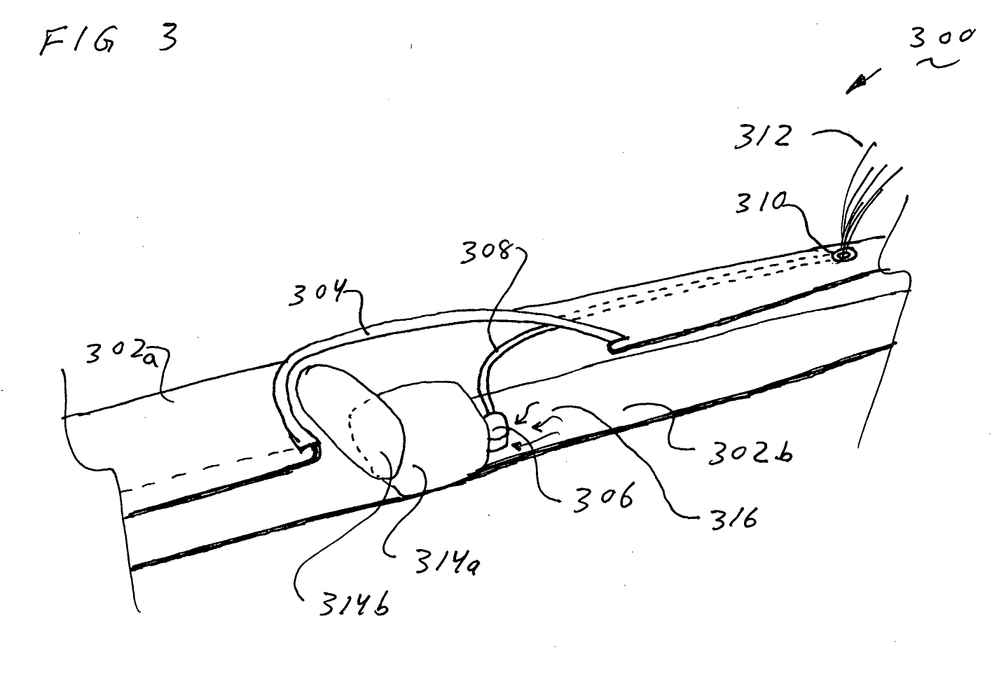

FIG. 3 illustrates, generally at 300, an isometric cut-away view of a system for expelling water using a thru-hull fitting according to an embodiment of the invention. With reference to FIG. 3, a deck 302a, has a cockpit coaming 304. A seat 314a is mounted to either 302a or the lower hull 302b. A seat back rest is indicated at 314b.

A water movement device 306 is mounted forward of 314a. Water movement device 306 draws water in as indicated by water 316. The water is moved through tube 308 and expelled at 312 from the interior of the personal watercraft exiting via a forward mounted thru-hull fitting 310.

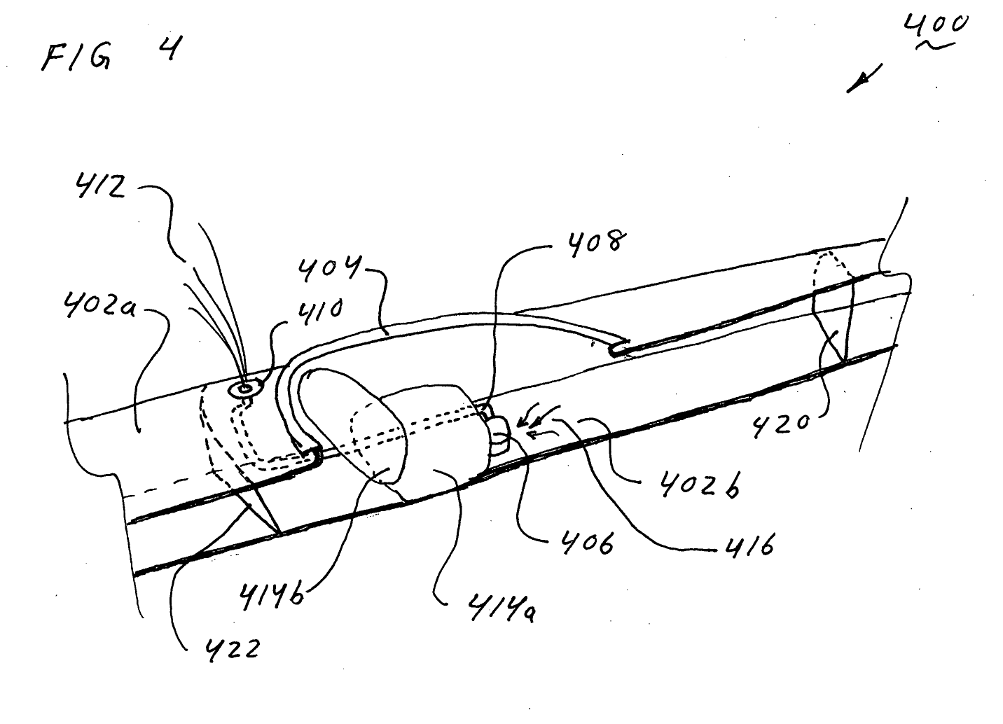

FIG. 4 illustrates, generally at 400, an isometric cut-away view of a system for expelling water using an aft mounted thru-hull fitting according to another embodiment of the invention. With reference to FIG. 4, a deck 402a, has a cockpit coaming 404. A seat 414a is mounted to either 402a or the lower hull 402b or to both. A seat back rest is indicated at 414b.

A water movement device 406 is mounted forward of 414a. Water movement device 406 draws water in as indicated by water 416. The water is moved through tube 408 and expelled at 412 from the interior of the personal watercraft via thru-hull fitting 410.

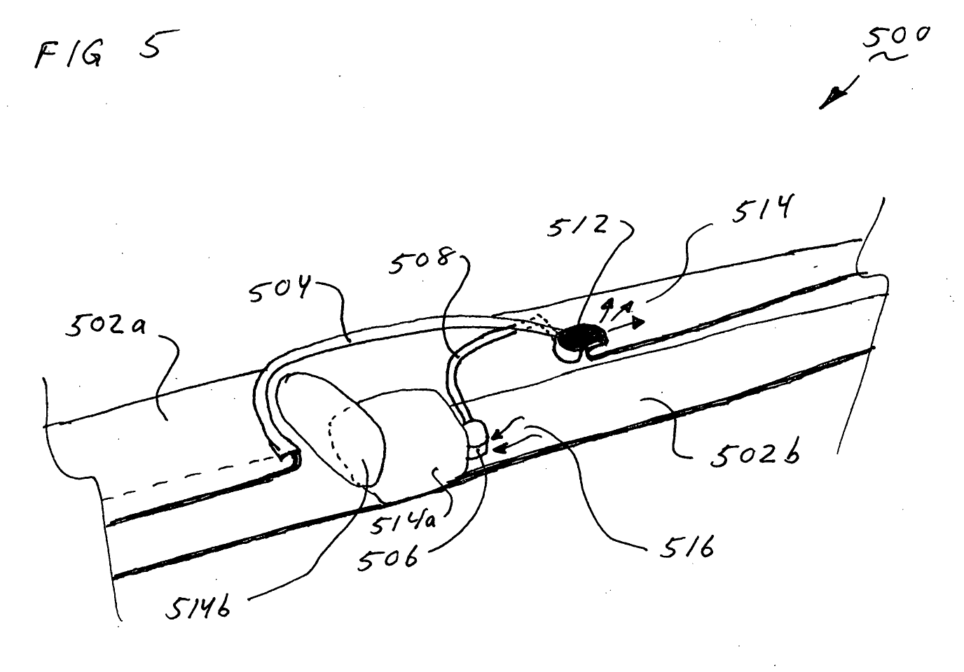

FIG. 5 illustrates, generally at 500, an isometric cut-away view of a system for expelling water that does not use a thru-hull fitting according to embodiments of the invention. With reference to FIG. 5, a deck 502a, has a cockpit coaming 504. A seat 514a is mounted to either 502a or the lower hull 502b or to both. A seat back rest is indicated at 514b.

A water movement device 506 is mounted forward of seat 514a. Water movement device 506 draws water in as indicated by water 516. The water is moved through tube 508 and is expelled at 512 from the interior of the personal watercraft via a device 512.

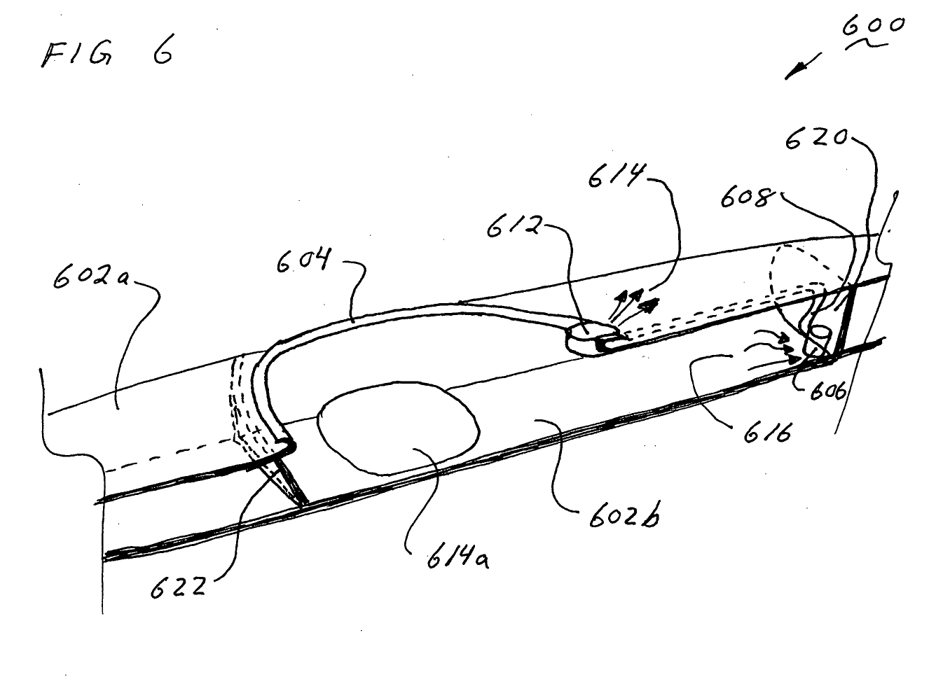

FIG. 6 illustrates, generally at 600, an isometric cut-away view of a system for expelling water that does not use a thru-hull fitting according to another embodiment of the invention. With reference to FIG. 6, a deck 602a, has a cockpit coaming 604. A seat is indicated at 614a. A seat back rest is not shown but could be included as shown at 514b (FIG. 5).

A water movement device 606 is mounted next to a forward bulkhead 620. Water movement device 606 draws water in as indicated by water 616. The water is moved through tube 608 and expelled at 614 from the interior of the personal watercraft via a device 612. An aft cockpit bulkhead 622 is shown but is not included in some personal watercraft.

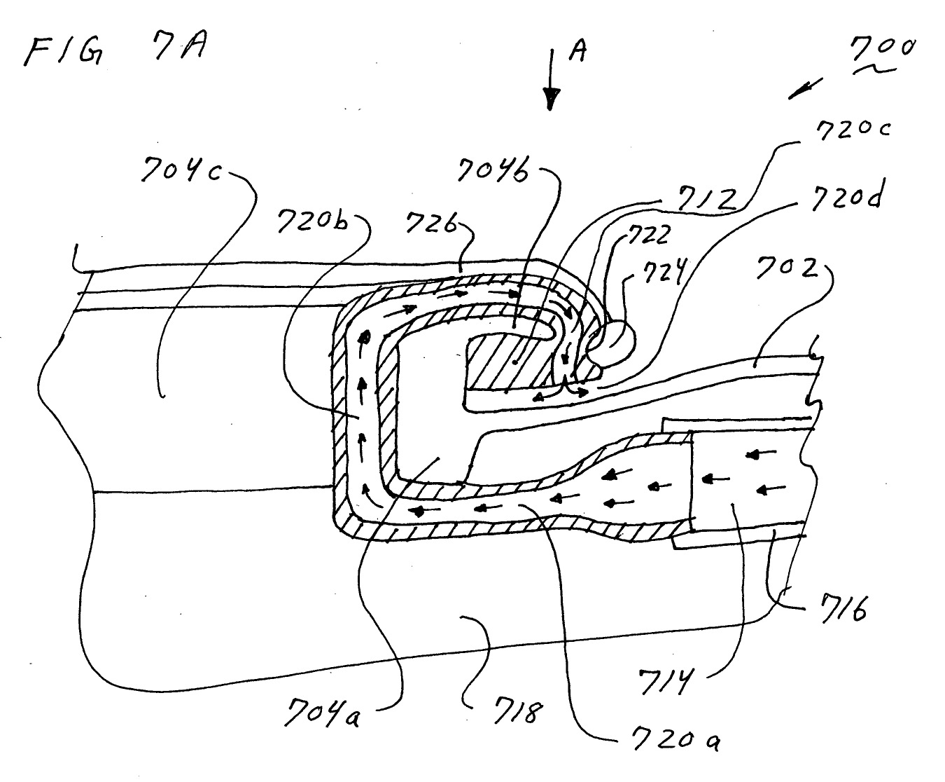

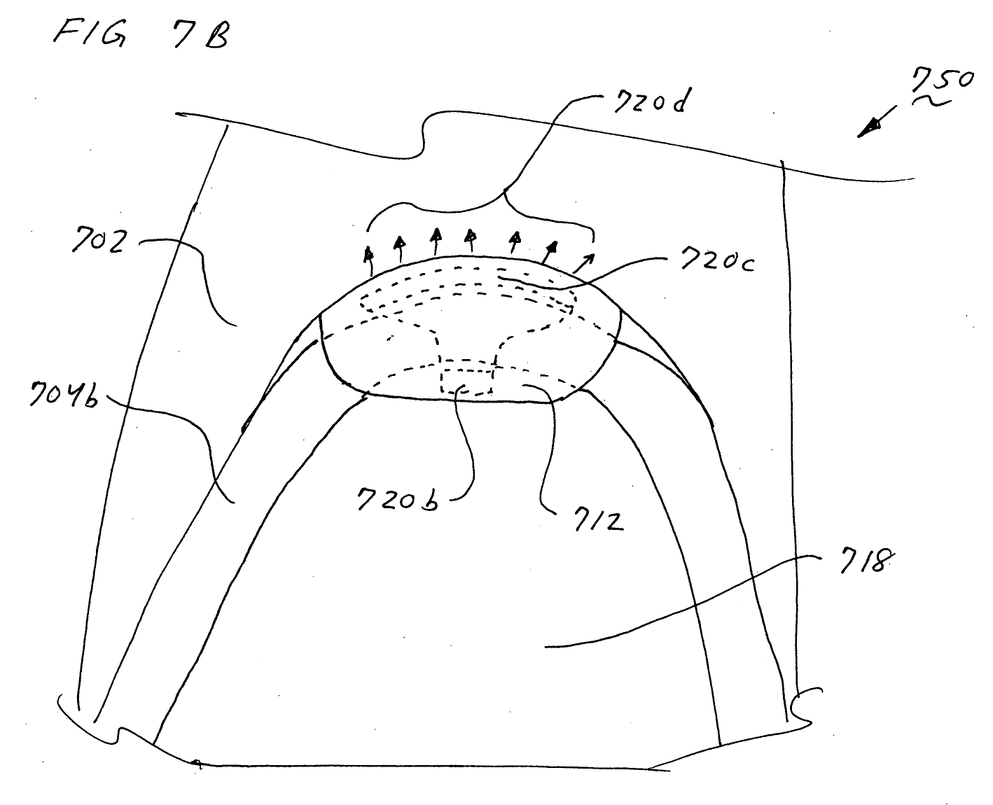

FIG. 7A illustrates, generally at 700, a cross-sectional view of a device for expelling water that does not use a thru-hull fitting according to an embodiment of the invention. With reference to FIG. 7A, a deck 702 has a cockpit opening framed by a coaming 704c. 704c has a top lip 704b and a lower shoulder 704a. A device 712 has a curved recess and fits around 704a. In one embodiment, the device 712 has an internal passage illustrated by 720a, 720b, 720c, that permits fluid to flow as indicated by 714 and exit at 720d from the device's fluid output port. A hose 716 is coupled to a fluid input of the device 712. A spray skirt 726 fits onto 712 and a spray skirt elastic 724 contacts 712 in groove 722. Thus, water is expelled from an inside of cockpit 718 to the outside of the cockpit without a thru-hull fitting penetrating the cockpit.

FIG. 7B illustrates, generally at 750, a top view of the device from FIG. 7A according to an embodiment of the invention. The internal passage indicated by 720b/720c (in dashed lines) can be a single passage or it can be implemented as multiple passages. Thus, the fluid output can be either a single port or a plurality of ports.

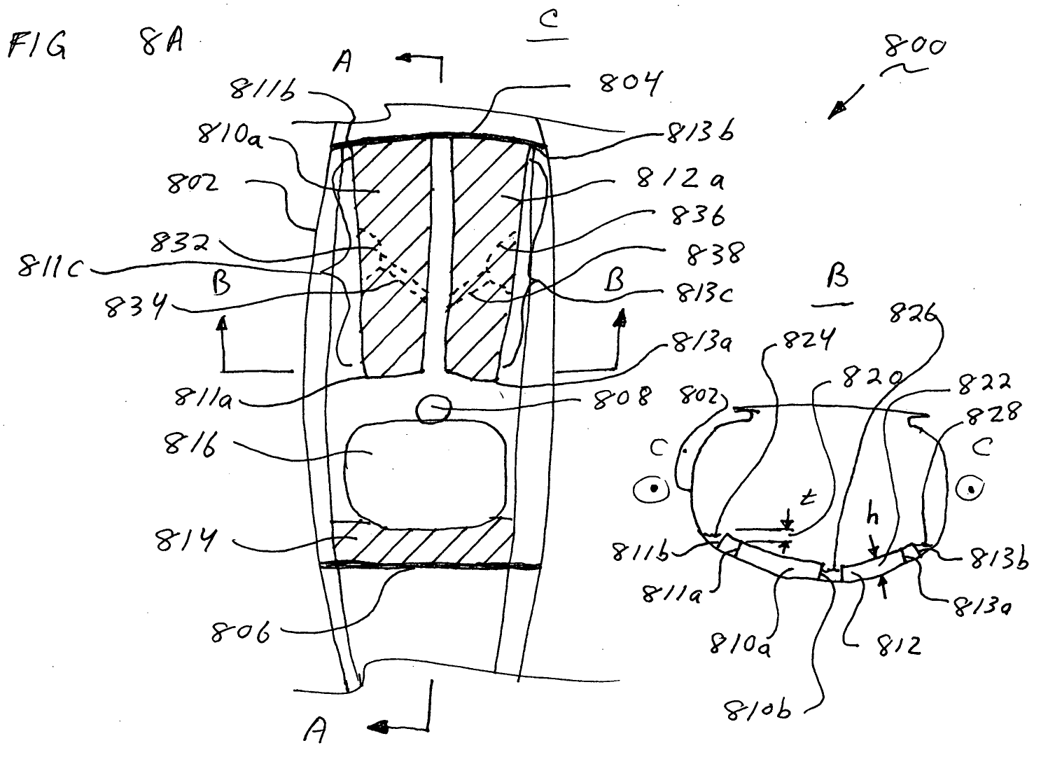

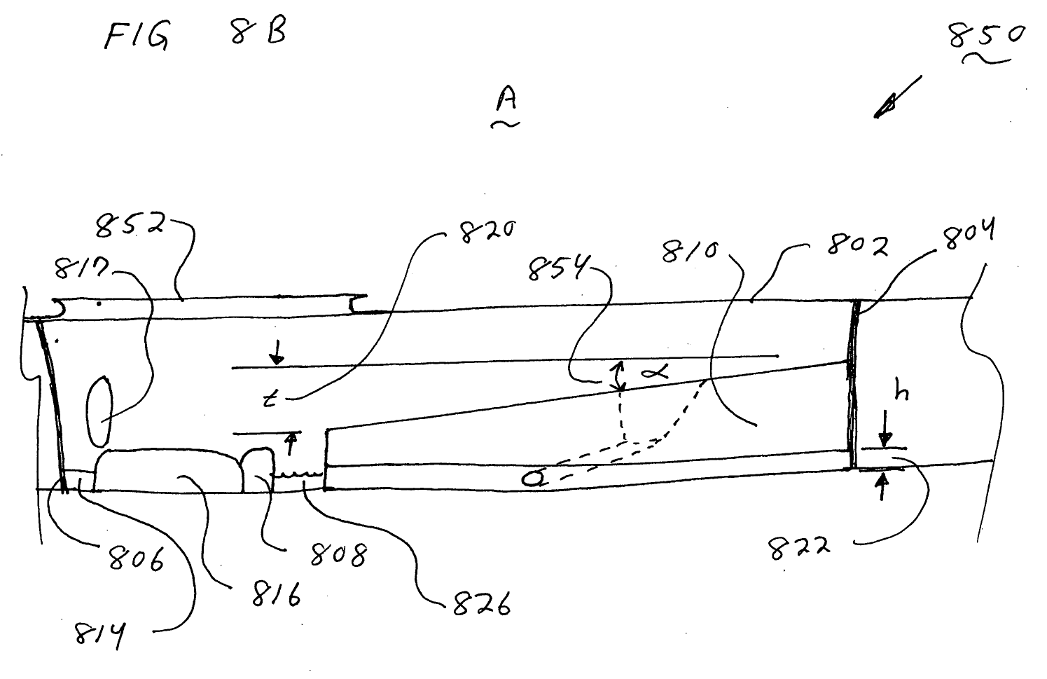

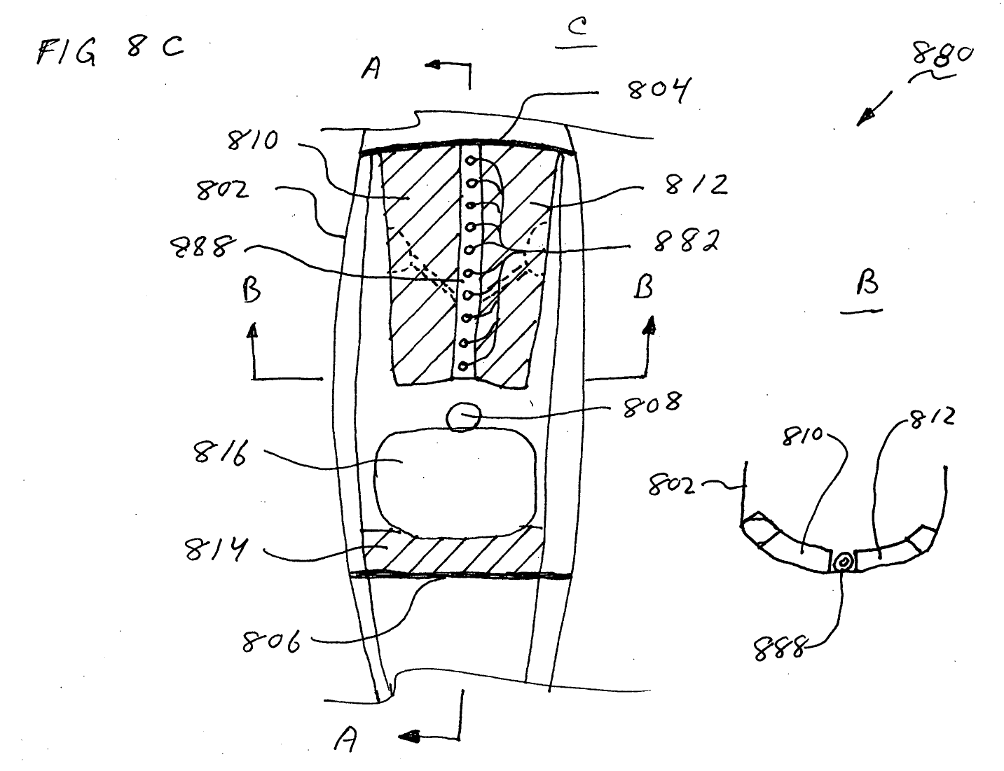

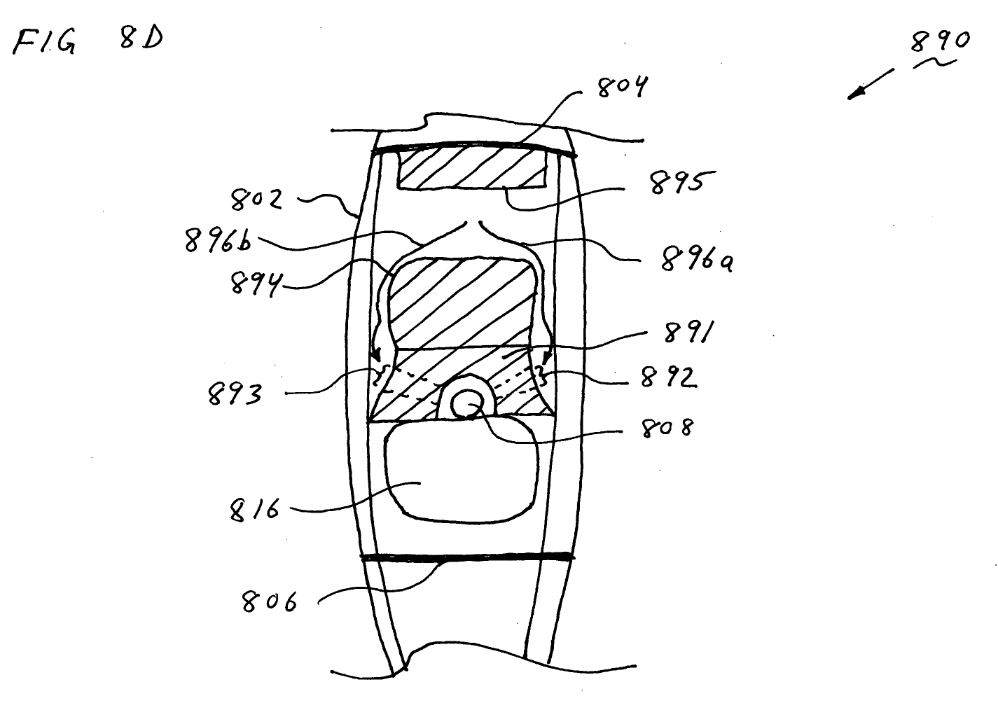

FIG. 8A illustrates a top view of a water confinement system according to an embodiment of the invention. With references to FIG. 8A, a cockpit of a personal watercraft is shown (with the top half of the hull removed) and a lower portion of a hull 802 remaining, a forward bulkhead 804, and an aft bulkhead 806. In one embodiment, a fluid movement device 808 is mounted forward of a seat 816. Displacement layers 810a and 812a are mounted to the inside of the floor of the cockpit. Optional cutouts for a user's feet are indicated at 832 and 836. Optional recesses for fluid to drain through are indicated at 834 and 838.

Forward cut-away view B shows fluid collecting at the lowest point in the hull, sump area 826 formed around the fluid movement device 808. As the personal watercraft rolls to starboard or port, water is captured at 826, 824, and at 828. Fluid that is captured at 824 between edge 811c and the inside surface of 802 drains into the region around the fluid movement device 808. Similarly, fluid that is captured between the edge 813c and the inside surface of 802 drains into the region of the fluid movement device 808. The fluid drains aft because the rear down slope provided between 811b and 811a and between 813b and 813a.

In one embodiment, a sump volume around the fluid movement device 808 is minimized by the addition of a displacement layer 814 aft of 816.

FIG. 8B illustrates, generally at 850, a side view of the system shown in FIG. 8A according to an embodiment of the invention. With reference to FIG. 8B, a cockpit coaming is indicated at 852 and a seat back rest at 817. A slope 854 exists at a rearward sloping angle α along edges 811c and 813c of 810 and 812 respectively (FIG. 8A). This rearward sloping angle lets fluid drain aft to the location of the fluid movement device 808 so that the fluid can be directed from the inside of the cockpit to the exterior of the cockpit using the fluid movement device 808.

FIG. 8C illustrates, generally at 880, a top view of a water confinement system according to another embodiment of the invention. With reference to FIG. 8C, a collection channel 888 is placed between 810 and 812. In one embodiment, the collection channel 888 has a number of ports 882 in its top side to allow fluid to flow therethrough into an interior of the collection channel 888. Once fluid drains into the interior of the collection channel 888 it is impeded from flowing out of the collection channel 888 when the personal watercraft rolls with ocean waves in a starboard or port motion. Confinement of the fluid within the collection channel 888 facilitates draining the fluid into the sump area 826 (FIG. 8B) so that it can be removed from the interior of the cockpit.

FIG. 8D illustrates, generally at 890, a top view of a water confinement system according to yet another embodiment of the invention. With reference to FIG. 8D, a displacement layer 891 is attached to the floor of personal watercraft 802. The displacement layer has a cutout that forms a sump around a fluid movement device 808. A channel 893 is formed in the displacement layer on the left side of the sump area. The channel 893 permits water 896b to flow into the sump area when the personal watercraft is titled to the left. A channel 892 is formed in the displacement layer on the right side of the sump area. The channel 892 permits water 896a to flow into the sump area when the personal watercraft is tilted to the right.

A second displacement layer 895 is attached to the floor of the cockpit forward of the displacement layer 891. A space between the displacement layer 891 and 895 allows the heels of the user's feet to rest on the floor of the personal watercraft so that the full height of the personal watercraft (floor to the underside of upper deck) is available for the user's feet. In this way the water confinement system does not obstruct the user's feet.

The displacement layers are preferably made from a light weight closed cell foam that does not absorb water. Types of foam that can be used for this purpose include but are not limited to Minicell® foam, Alveolit® foam, Softlon®. Minicell® foam is a chemically cross-linked polyethylene foam that can be fixed to the inside surface of the personal watercraft with an adhesive such as 3M's Scothweld®, Weldood® contact cement, or West System's G/flex® epoxy.

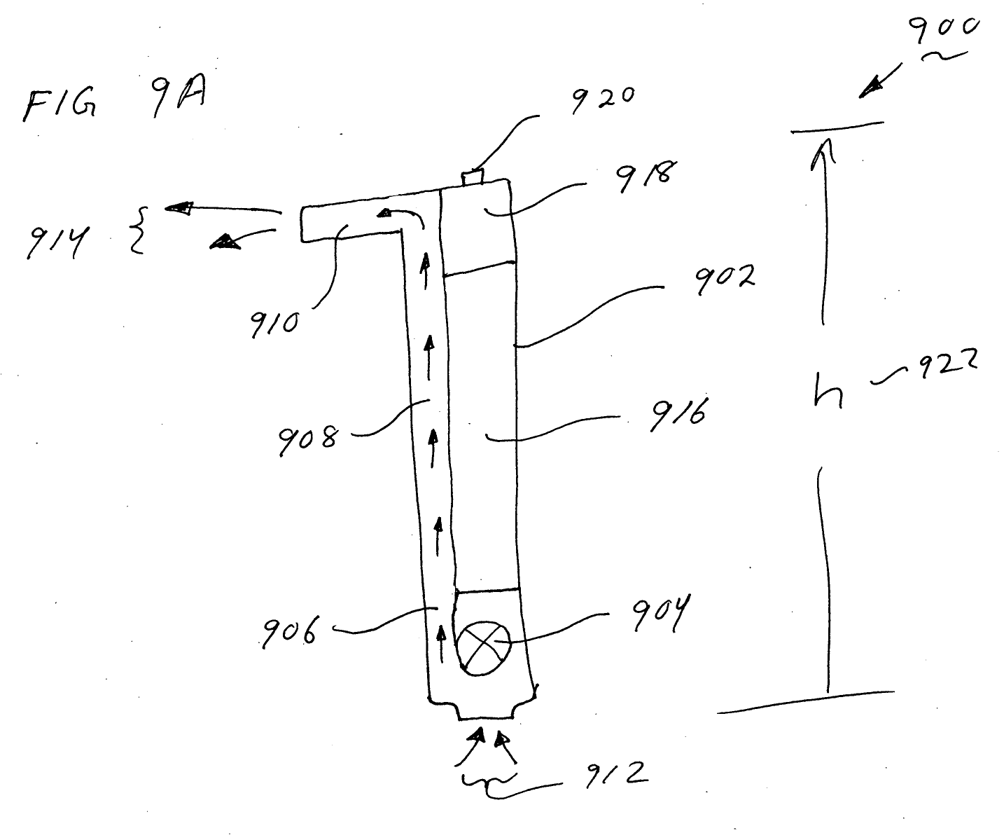

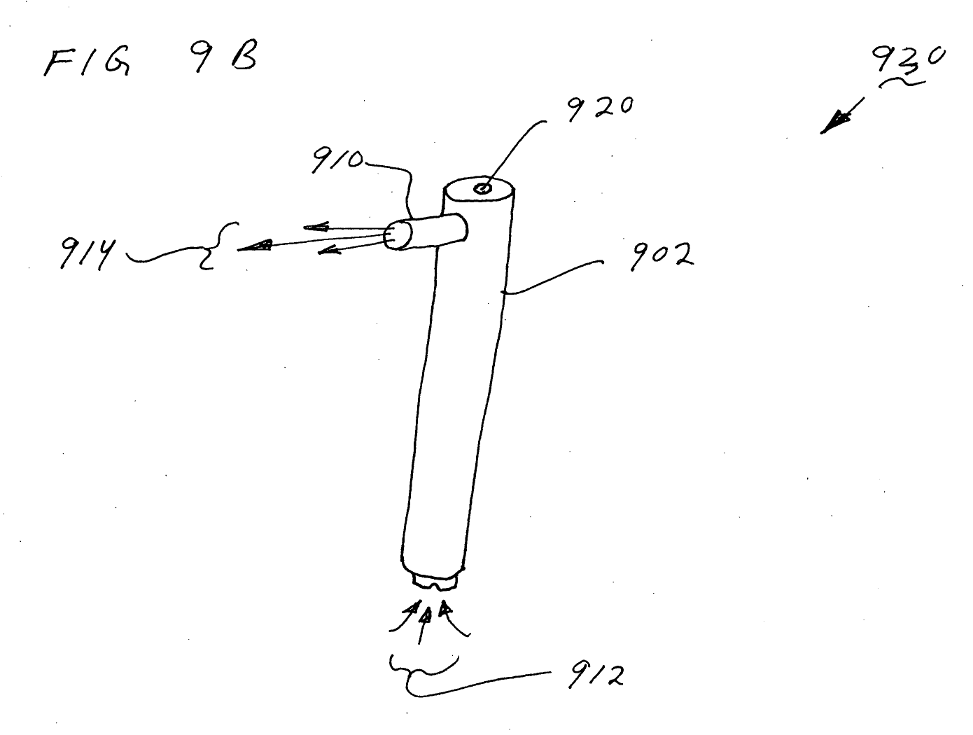

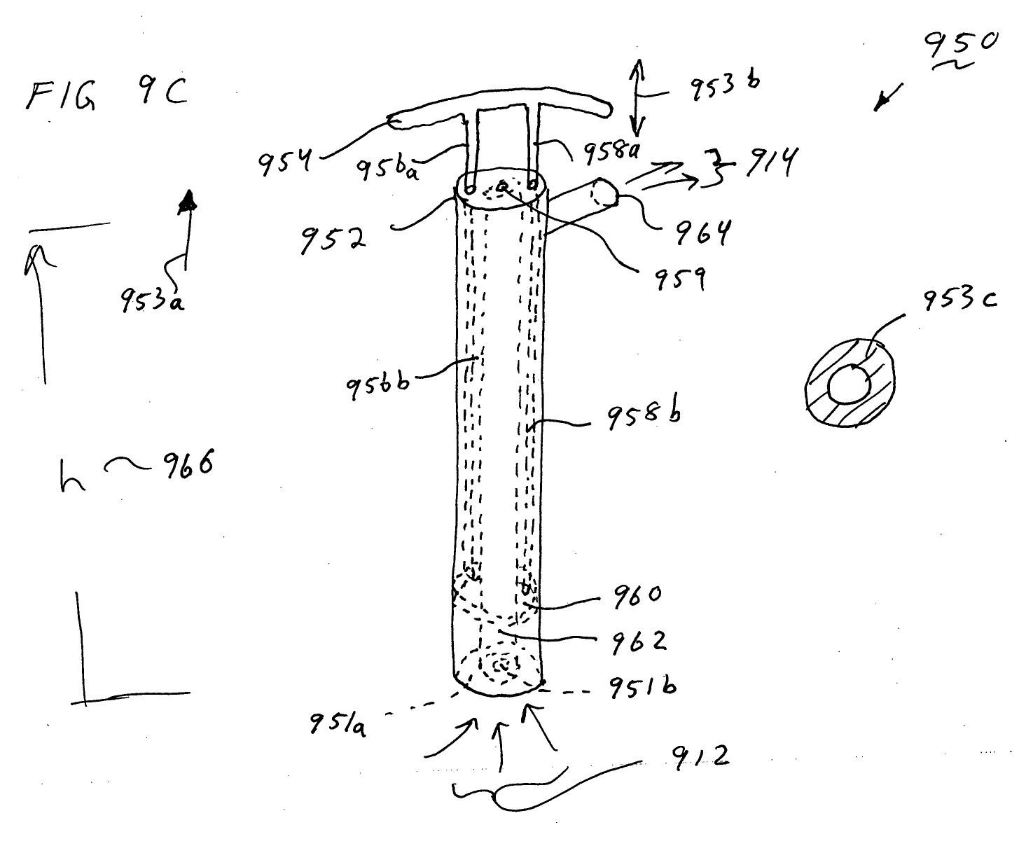

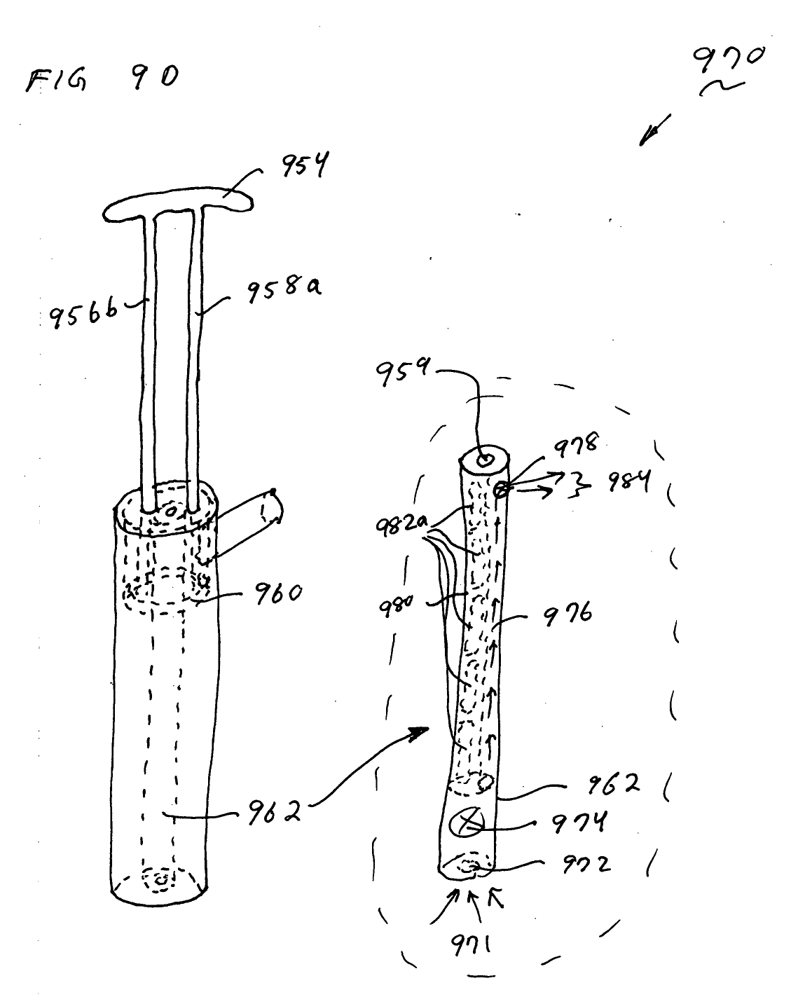

FIG. 9A illustrates, generally at 900, a side cut-away view of a portable system for expelling water according to an embodiment of the invention. With reference to FIG. 9A, a device 902 has a fluid movement device 904, a fluid input 912 thereto, an interior fluid channel 906/908/910, an electrical power compartment 916, a switch 918 with actuator 920. In one embodiment, when the switch 920 is depressed, electrical power flows to the fluid movement device 904, the fluid movement device 904 moves fluid from 912 up a height h, indicated at 922 and out of 910 as indicated at 914. In various embodiments, actuator 920 is a magnet, a pushbutton, a rocker, etc.

FIG. 9B illustrates, generally at 930, an isometric view of the system shown in FIG. 9A according to an embodiment of the invention.

FIG. 9C illustrates, generally at 950, an isometric view of a hybrid electric/mechanical portable system for expelling fluid/water according to an embodiment of the invention. With reference to FIG. 9C, a device 952 has a fluid input 951a through which fluid 912 enters when a handle 954 is raised in a direction 953a. When the handle 954 is raised in direction 953a fluid enters the annular region 953c through a one-way valve at the fluid input 951a and fills a volume created within 952 beneath piston 960. When the handle 954 is depressed fluid flows through a one-way valve in the piston 960 from beneath the piston 960 to above the piston 960. In one embodiment the valve in the piston 960 can be a flapper valve, which provides a one-way flow of fluid into the volume above the piston so that the fluid 914 is expelled out of 964 when the handle is raised in the direction 953a on the next stroke.

954 is connected by rods 956a/958a to piston 960. 960 moves as indicated by arrow 953b.

Within the envelope of 952 is a system for moving fluid with input at 951b and the fluid so moved is output at 964 as shown at 914. 962 contains a fluid movement device such as a pump, a source of electrical power, and a switch 959 all in a waterproof container. Thus 950 can either be operated by hand or by electrical power. In either mode of operation fluid is moved a distance indicated by h at 966.

FIG. 9D illustrates, generally at 970, another isometric view of a hybrid electric/mechanical portable system for expelling water with detail according to an embodiment of the invention. With reference to FIG. 9D, a detail view of 962 is illustrated according to one embodiment. Fluid 971 enters port 972 and is moved by fluid movement device 974 up through a passage 976 and out a port 978 at 984. Electrical power source 982a powers 974 and a user uses a switch 959 to turn fluid movement device 974 on and off.

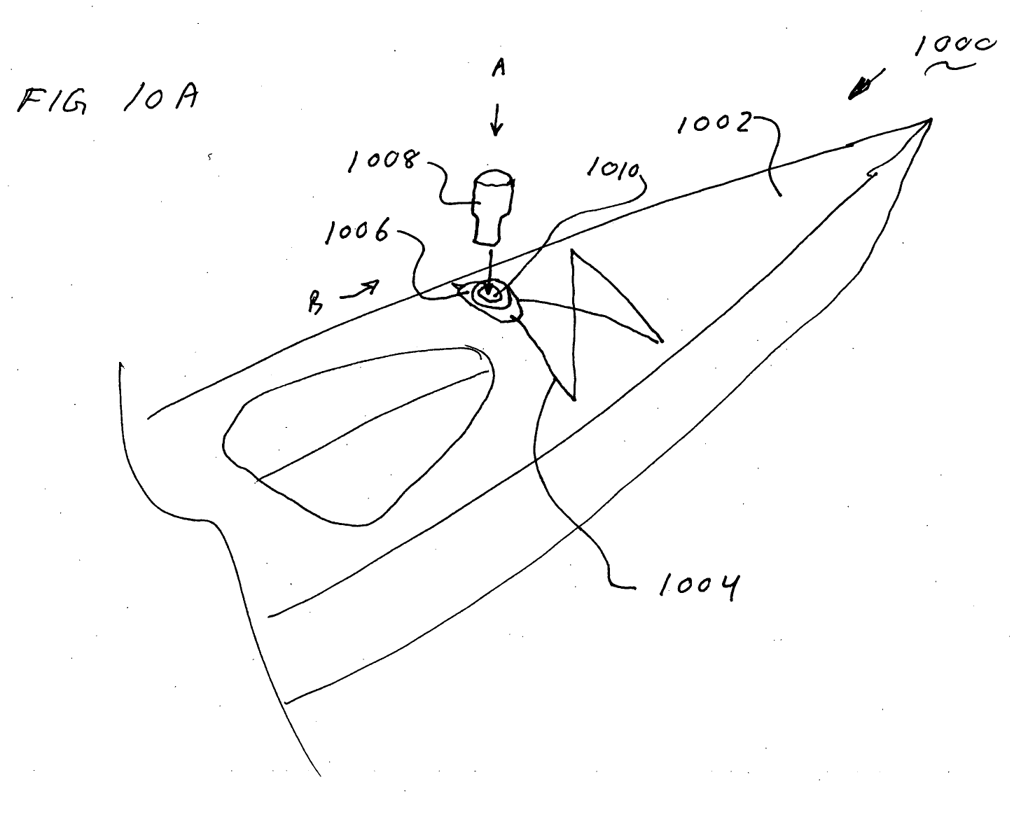

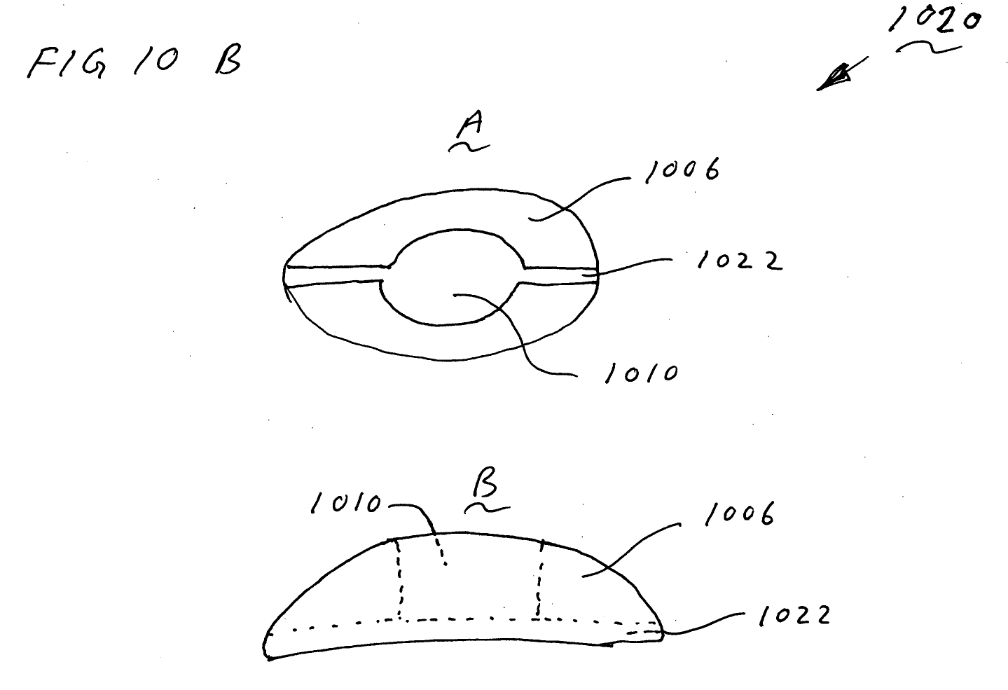

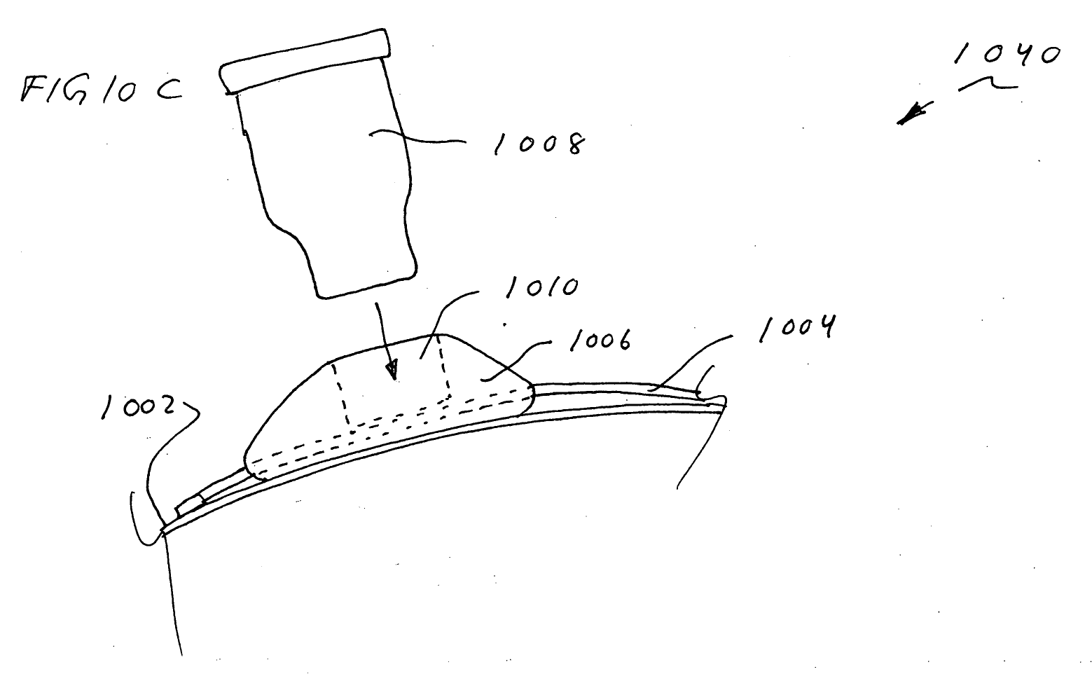

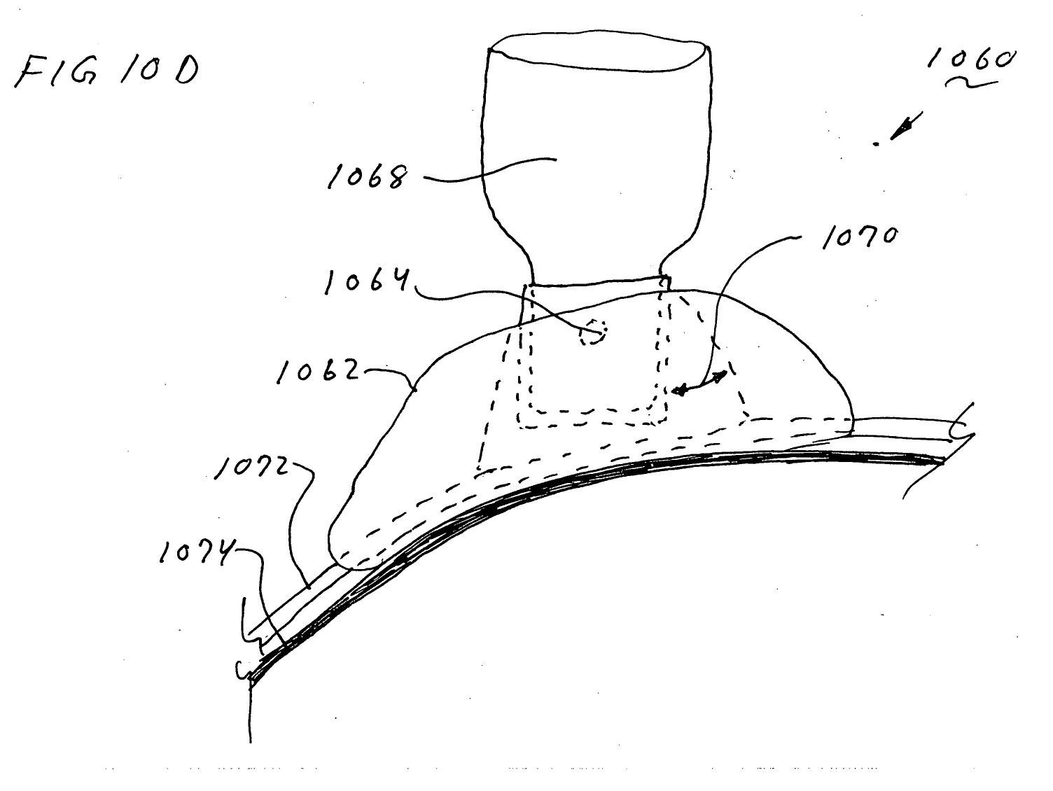

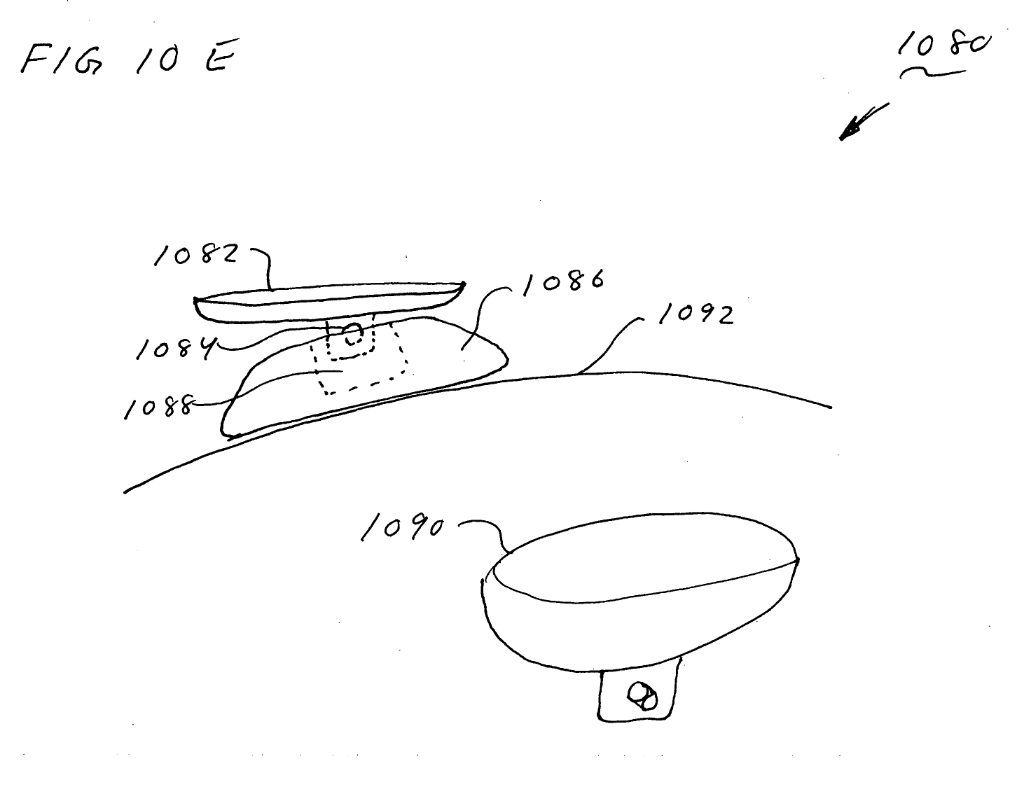

FIG. 10A illustrates, generally at 1000, an isometric view of a cup/mug holding device for a personal watercraft according to an embodiment of the invention. With reference to FIG. 10A, a personal watercraft 1002 has a deck bungee or deck line 1004 to which is attached a device 1006. The device 1006 has a recess 1010 to receive a cup 1008. The device 1006 and the bottom of the cup 1008 are releasably coupleable with each other within the recess 1010.

FIG. 10B illustrates, generally at 1020, a top and side view of the holding device from FIG. 10A according to an embodiment of the invention. With reference to FIG. 10B, a top view of the device 1006 is presented in view A. In one embodiment, a slot 1022 permits the bungee or deck line 1004 to rest therein and thereby hold the device against the personal watercraft 1022. The configuration of the slot 1022 permits the device to be easily removed from the deck of the personal watercraft 1002 by lifting the bungee away from the deck. In another embodiment, the slot is replaced with a hole through which the bungee is threaded. In such an embodiment, the bungee must be untied in order to remove the device 1008.

FIG. 10C illustrates, generally at 1040, a side view of a cup/mug holder for a personal watercraft according to another embodiment of the invention. With reference to FIG. 10C, a cup/mug 1008 is releasably coupleable within a recess 1010 of a device 1006, which is held against a deck of a personal watercraft 1002 by a bungee or deck line 1004.

FIG. 10D illustrates, generally at 1060, a side view of a cup/mug holder for a personal watercraft according to another embodiment of the invention. With reference to FIG. 10D, a device 1062 contains a receptacle 164, which pivots on a rotatable member 1066 thereby permitting a range of motion indicated at 1070. A cup or mug 1068 will stay in a vertical position as the personal watercraft rolls to the left or right. The device 1062 is held against a deck of the personal watercraft 1074 by a deck bungee or deck line 1072.

FIG. 10E illustrates, generally at 1080, an isometric view of a plate/bowl holder for a personal watercraft according to another embodiment of the invention. With reference to FIG. 10E, a device 1086 is configured with a recess 1088 to receive a base 1084 of a plate 1082. The device 1086 sits on top of the deck of a personal watercraft 1092 and is attached via a deck bungee or deck line as previously described in FIGS. 10A-10D. The plate 1082 can be removed from the device 1086 and a bowl 1090 can be inserted in its place. In this way, it is possible for a user of a personal watercraft to have a drink in a mug or cup held fast in a device and food can be held on a plate or bowl while the user is paddling the personal watercraft. Such devices are useful when paddling during a time when the user would like to have food and drink available above deck.

In this detailed description of embodiments, fluid can be salt water or fresh water or water that has an amount of biological growth in it. Fluid is not limited but includes any fluid that a user would use a personal watercraft in.

Cup/mug holders and plate bowl holders can be made from closed cell foam such as Minicell® foam injection molded plastic, wood or any material that is lightweight. The holders are designed to be releasably coupleable to the deck bungee or deck lines on the surface of a personal watercraft. Deck lines are often made from nylon cord and bungee is often made from nylon wrapped elastic cord. As used in this description of embodiments, personal watercraft includes but is not limited to all forms of kayaks, canoes, etc. kayaks include but are not limited to recreational kayaks, touring kayaks, sea kayaks, white water kayaks. Cockpit as used in this description of embodiments means the inside of a personal watercraft, such as the inside of a kayak or the inside of a canoe.

The systems taught herein for expelling water from the cockpit can combine all of the system components into one container or distribute the components between multiple containers. For example, fluid movement device 102 and the switch 112 can be combined into weatherproof compartment 110 (FIG. 1A) and the resulting integration of components can be located at 210 (FIG. 2A, 2B, 2C, 2D), 290 (FIG. 2E), 306 (FIG. 3), 406 (FIG. 4), 506 (FIG. 5), 606 (FIG. 6), 808 (FIG. 8A, 8B, 8C). Alternatively, switch 112 and fluid movement device 102 can be combined together in an automatic fluid movement device and located anywhere a fluid movement device has been illustrated.

As used in this description of embodiments, the term personal watercraft is not limited to a single person but includes tandem and triple kayaks as well as multi-person canoes and other watercraft that can accommodate more than one person.

The systems described above that remove fluid from personal watercraft electrically; enable a user to expel the water that enters a typical 18-foot sea kayak following a wet exit in approximately 1 minute. In one embodiment, such a system consists of a nominally 500 gallon per hour pump powered by a 14.8 volt 2200 mAh Lithium Ion battery. This is accomplished with the spray skirt on with two hands on the paddle and two feet on the foot-pegs. The systems described herein are extendable to dual cockpit and triple cockpit kayaks by placing a pump in each compartment and by running wires for power.

For purposes of discussing and understanding embodiments of the invention described herein, it is to be understood that various terms are used by those knowledgeable in the art to describe techniques and approaches. Furthermore, in this description, for purposes of explanation, numerous specific details are set forth in order to provide a thorough understanding of the embodiments of the invention presented. It will be evident, however, to one of ordinary skill in the art that embodiments of the invention may be practiced without these specific details. In some instances, well-known structures and devices are shown in block diagram form, rather than in detail, in order to avoid obscuring embodiments of the invention. These embodiments are described in sufficient detail to enable those of ordinary skill in the art to practice the invention, and it is to be understood that other embodiments may be utilized and that logical, mechanical, electrical, and other changes may be made without departing from the scope of the embodiments of the invention described.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

As used in this description, “one embodiment” or “an embodiment” or similar phrases mean that the feature(s) being described is included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of skill in the art will recognize that the invention is not limited to the embodiments described, but can be practiced with modification and alteration within the spirit and scope of the appended claims. The description is thus to be regarded as illustrative instead of limiting.

What is claimed is:

1. A system for electrically expelling water from a personal watercraft comprising:
a waterproof container, the waterproof container defining a volume;
a portable source of electrical power, the portable source of electrical power is within the volume;
a fluid movement device, the fluid movement device is electrically connected with the portable source of electrical power and the fluid movement device is outside the waterproof container;
a switch, the switch is electrically connected to the portable source of electrical power, the switch has an on position and an off position; and
a first mounting bracket, the first mounting bracket has a first end and a second end, the first end has a first mounting position, the fluid movement device is attached at the first mounting position and the second end is held under a seat of the personal watercraft, when the switch is in the on position the fluid movement device will pump water and when the fluid movement device is in the off position the pump will not pump water.

2. The system of claim 1, wherein the switch is a magnetic reed switch.

3. The system of claim 2, wherein the waterproof container is secured to the second end of the first mounting bracket.

4. A system for electrically expelling water from a personal watercraft comprising:
a weather proof container, the weather proof container defining a volume;
a portable source of electrical power, the portable source of electrical power is within the volume;
a charging cable having a first end and a second end, the first end is connected to the portable source of electric power and the second end is outside the weather proof container, the second end has a weather proof electrical/mechanical connector with a removable sealing cap the second end can connect to a source of electrical energy to charge the battery;
a fluid movement device, the fluid movement device is electrically connected with the portable source of electrical power and the fluid movement device is outside the weather proof container;
a switch, the switch is electrically connected to the portable source of electrical power, the switch has an on position and an off position; and
a first mounting bracket, the first mounting bracket has a first end and a second end, the first end has a first mounting position, the fluid movement device is attached at the first mounting position and the second end is held under a seat of the personal watercraft, when the switch is in the on position the fluid movement device will pump water and when the fluid movement device is in the off position the pump will not pump water.

5. The system of claim 4, further comprising:
a fuse, the fuse is placed in a location selected from the group consisting of inside the weather proof container and outside the weather proof container.

6. The system of claim 5, further comprising:
a second mounting bracket, the second mounting bracket is coupleable to the first mounting bracket.

7. The system of claim 6, wherein the weatherproof container is releasably coupleable to one of the first mounting bracket or the second mounting bracket.

8. The system of claim 6, wherein the portable source of electric power is a battery selected from the group consisting of Nickel Cadmium (NiCd), Nickel Metal Hydride (NiMH), Lithium Ion (Li-Ion), Lithium Polymer (Lipo), and Lithium Ferro Phosphate (LiFePO4).

9. A wiring harness for a system for electrically expelling water from a personal watercraft comprising:
a charging cable having a first end and a second end, the first end has a first electrical/mechanical connector the second end is outside the waterproof container, the second end has a waterproof electrical/mechanical connector with a removable sealing cap the waterproof electrical/mechanical connector can connect to a charging potential to charge a portable source of electrical power;
a second electrical/mechanical connector, the second electrical/mechanical connector is releasably coupleable to the first electrical mechanical connector or to the charging potential;
a third electrical/mechanical connector, the third electrical/mechanical connector is releasably coupleable to a portable source of electrical power;
a wiring harness, the wiring harness connects in parallel the second electrical/mechanical connector and the third electrical/mechanical connector and permits electrical connection to a fluid movement device.

10. A water confinement system for a personal watercraft, comprising:
a displacement layer, the displacement layer is attached to the floor of a cockpit of the personal watercraft and the displacement layer is mounted in front of a fluid movement device to form a sump around the fluid movement device.

11. The water confinement system of claim 10, wherein the displacement layer contains a channel through which water can flow into the sump.

12. The water confinement system of claim 11, wherein the displacement layer is made up of more than one piece of material.

13. The water confinement system of claim 11, wherein the displacement layer is made from closed cell foam.

14. An apparatus for discharging water from a cockpit of a personal watercraft, comprising:
a device, the device further comprising:
a fluid input;
a fluid output, the fluid input is located within the cockpit, the fluid output is located outside of the cockpit, the device has a curved recess and receives the coaming of the cockpit within the curved recess; such that water that enters the fluid input leaves the cockpit through the fluid output.

15. A portable device for electrically expelling water from a cockpit of a personal watercraft, comprising:
a rigid housing, the rigid housing further comprising:
a dry compartment; and
a fluid channel, the fluid channel having an input and an output;
a portable source of electrical power, the portable source of electrical power is mounted within the dry compartment;
a fluid movement device, the fluid movement device is mounted within the rigid housing and the fluid movement device is electrically connected with the portable source of electrical power, the fluid movement device moves fluid through the fluid channel from the input to the output;
a switch, the switch is electrically connected to the portable source of electrical power, the switch has an on position and an off position, when the switch is in the on position the fluid movement device will move water through the fluid channel and out the output thereby expelling water from the cockpit of a personal watercraft and when the switch is in the off position the fluid movement device will not move water.

16. A portable device for expelling water from a cockpit of a personal watercraft, comprising:
a rigid housing, the rigid housing further comprising:
a siphon pump, the siphon pump having a fluid input, a fluid output, a piston, and a plunger, the plunger is connected to a handle;
a dry compartment; and
a fluid channel, the fluid channel having an input and an output;
a portable source of electrical power, the portable source of electrical power is mounted within the dry compartment;
a fluid movement device, the fluid movement device is mounted within the rigid housing and the fluid movement device is electrically connected with the portable source of electrical power, the fluid movement device moves fluid through the fluid channel from the input to the output;
a switch, the switch is electrically connected to the portable source of electrical power, the switch has an on position and an off position, when the switch is in the on position the fluid movement device will move water through the fluid channel and out the output thereby expelling water from the cockpit of a personal watercraft and when the switch is in the off position the fluid movement device will not move water; fluid can be moved by pulling and pushing the handle relative to the compartment thereby expelling fluid from the cockpit.

17. An apparatus comprising:
a device, the device is configured to be held against a deck of a personal watercraft by a deck line or bungee;
a mug, the mug is configured to be received by the device, such that a user can releasably couple the mug from the device while the user is paddling the personal watercraft.
